(19) United States
(12) Patent Application Publication
(10) Pub. No.: US 2026/0201119 A1
(43) Pub. Date: Jul. 16, 2026

(54) CARBOXYMETHYLATED LYSINE-BASED POLYMER AND COMPOSITIONS COMPRISING THE SAME

(71) Applicant: BASF SE, Ludwigshafen am Rhein (DE)

(72) Inventors: Alexandros LAMPROU, Shanghai (CN); Xu LU, Shanghai (CN); Helmut WITTELER, Ludwigshafen (DE); Juergen DETERING, Ludwigshafen (DE); Claudia ESPER, Ludwigshafen (DE); Markus HARTMANN, Ludwigshafen (DE); Kai ZHUANG, Shanghai (CN); Yan KANG, Shanghai (CN)

(21) Appl. No.: 19/138,836

(22) PCT Filed: Dec. 22, 2022
(86) PCT No.: PCT/CN2022/141035

§ 371 Date: Jun. 13, 2025

(51) Int. Cl. C08G 69/48; C08G 69/10; C11D 3/37; D21C 9/10; D21C 9/16

(52) U.S. Cl. CPC C08G 69/48; C08G 69/10; C11D 3/3719; D21C 9/1042; D21C 9/163

(57) ABSTRACT

Described herein are a carboxymethylated lysine-based polymer including (A) 60 to 99 mol % of structural units from lysine monomer, and (B) 1 to 40 mol % of structural units from at least one dicarboxylic acid of formula (I) HOOC—R₁—COOH or amide-forming derivative thereof, where R₁ is a direct bond or an aliphatic linear hydrocarbylene and a process for preparing the same. Described herein are a detergent composition and a peroxy bleaching composition including the carboxymethylated lysine-based polymer.

### FIELD OF THE INVENTION

The present invention relates to a carboxymethylated lysine-based polymer, a process of preparation thereof, detergent compositions comprising the carboxymethylated lysine-based polymer and use of the carboxymethylated lysine-based polymer in detergent compositions.

### BACKGROUND ART

Nowadays, dispersing agents play an important role in various industrial and household formulations, for example in laundry detergent formulations for the prevention of greying of textile and in automatic dishwashing detergent formulations for the prevention of scaling on the ware. Dispersing efficacy to avoid undesirable phenomenon such as scaling or soil depositing, for example in washing, cleaning processes were always pursued for the development of dispersing agents.

Chelating agent is also an important additive in industrial formulations for example for paper manufacturing, and household formulations for example for washing and cleaning processes, especially in hard water areas.

In recent years, a new trend of additive development is to provide environmental-friendly phosphorus-free additives with the improvement of public environmental protection awareness and more environmental regulatory requirements worldwide. With such a trend, biodegradable dispersing agents and chelating agents bring new challenges for the manufacturers.

There is thus a need to provide a biodegradable chemical as dispersing agents and/or chelating agents useful in industrial and household formulations.

### SUMMARY OF THE INVENTION

It is an object of the present invention to provide a biodegradable chemical as a dispersing and/or chelating agent, particularly one having both chelating and dispersing functions.

It has been found that the object of the present invention can be achieved by a carboxymethylated lysine-based polymer obtained from polycondensation of monomers comprising lysine and at least one dicarboxylic acid and carboxymethylation.

In one aspect, the present invention relates to a carboxymethylated lysine-based polymer comprising
(A) 60 to 95 mol % of structural units from lysine monomer,
(B) 5 to 40 mol % of structural units from at least one dicarboxylic acid of formula (I) or amide-forming derivative thereof

HOOC—R₁—COOH (I)
wherein
R₁ is a direct bond or an aliphatic linear hydrocarbylene, which is unsubstituted or substituted with at least one group selected from unsubstituted or substituted alkyl, unsubstituted or substituted alkoxy, unsubstituted or substituted alkylthio, unsubstituted or substituted alkylamino, di(alkyl)amino, alkylidene, hydroxyl, mercapto, amino and halogen.

In another aspect, the present invention relates to a process for preparing the carboxymethylated lysine-based polymer, which comprises
thermal polycondensation of monomers comprising
(A) 60 to 99 mol % of lysine monomer,
(B) 1 to 40 mol % of at least one dicarboxylic acid of formula (I) or amide-forming derivative thereof

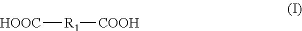

wherein
R₁ is a direct bond or an aliphatic linear hydrocarbylene, which is unsubstituted or substituted with at least one group selected from unsubstituted or substituted alkyl, unsubstituted or substituted alkoxy, unsubstituted or substituted alkylthio, unsubstituted or substituted alkylamino, di(alkyl)amino, alkylidene, hydroxyl, mercapto, amino and halogen, to obtain a lysine-based polymer, and
carboxymethylation of the lysine-based polymer.

In still another aspect, the present invention relates to a detergent composition or a peroxy bleaching composition, which comprises the carboxymethylated lysine-based polymer as described in the first one aspect.

In yet another aspect, the present invention relates to use of the carboxymethylated lysine-based polymer as described in the first one aspect in a detergent composition or a peroxy bleaching composition.

In a further aspect, the present invention relates to use of the carboxymethylated lysine-based polymer as described in the first one aspect as a chelating and/or dispersing agent.

It has been surprisingly found that the carboxymethylated lysine-based polymer according to the present invention shows comparable or even better chelating and/or dispersing performances than commercially available non-biodegradable chelating agents and dispersing agents, while having acceptable biodegradability.

### DETAILED DESCRIPTION OF THE INVENTION

The present invention now will be described in detail hereinafter. It is to be understood that the present invention may be embodied in many different ways and shall not be construed as limited to the embodiments set forth herein. Unless mentioned otherwise, all technical and scientific terms used herein have the same meaning as commonly understood by one of ordinary skill in the art to which the present invention belongs.

As used herein, the singular forms “a”, “an” and “the” include plural referents unless the context clearly dictates otherwise.

As used herein, the terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

As used herein, the term “biodegradable”, generally refers to a material that degrades from the action of naturally occurring microorganisms, such as bacteria, fungi, and algae, environmental heat, moisture or other environmental factors.

As used herein, the term “lysine-based polymer” is intended to indicate a polymer wherein lysine accounts for a major molar proportion, for example no less than 50 mol % of all monomers constituting the polymer.

As used herein, the term “carboxymethylated lysine-based polymer” is intended to refer to a lysine-based polymer which has been modified by carboxymethylation of the free amino groups remaining in the lysine-based polymer. It will be understood that the terms “carboxymethylated lysine-based polymer” is intended to include partially or completely neutralized forms with respect to the carboxyl groups introduced via carboxymethylation.

As used herein, the term “structural units” is intended to refer to the minimal molecular residues resulting from respective monomers after polycondensation. It will be understood that the term “structural units” may also refer to molecular residues resulting from a monomer after polycondensation and carboxymethylation if the monomer has an amino group that may survive the polycondensation.

Herein, the terms “structural unit(s) from lysine monomer” and “lysine structural unit(s)” are used interchangeably. Likewise, the terms “structural units from at least one dicarboxylic acid of formula (I) or amide-forming derivative thereof” and “dicarboxylic acid structural unit(s)” are used interchangeably.

As used herein, the K-value, when mentioned for the carboxymethylated lysine-based polymers according to the present invention, refers to corresponding parameters of the lysine-based polymers without carboxymethylation, unless the context clearly dictates otherwise.

### <Carboxymethylated Lysine-Based Polymer>

The carboxymethylated lysine-based polymer according to the present invention comprises
(A) 60 to 99 mol % of structural units from lysine monomer,
(B) 1 to 40 mol % of structural units from at least one dicarboxylic acid of formula (I) or amide-forming derivative thereof

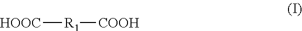

wherein
R₁ is a direct bond or an aliphatic linear hydrocarbylene, which is unsubstituted or substituted with at least one group selected from unsubstituted or substituted alkyl, unsubstituted or substituted alkoxy, unsubstituted or substituted alkylthio, unsubstituted or substituted alkylamino, di(alkyl)amino, alkylidene, hydroxyl, mercapto, amino and halogen.

The term “aliphatic linear hydrocarbylene” as used herein refers to a divalent radical derived from an unsaturated or saturated acyclic hydrocarbon, which may be optionally interrupted by at least one heteroatom selected from O, S and N. Typically, hydrocarbylene groups herein will have from 1 to 24 carbon atoms (C₁-C₂₄-hydrocarbylene), preferably 1 to 18 carbon atoms (C₁-C₁₈-hydrocarbylene), more preferably 1 to 12 carbon atoms (C₁-C₁₂-hydrocarbylene). Examples of aliphatic linear hydrocarbylene groups are especially alkylene and alkenylene.

The term “alkylene” as used herein refers to saturated divalent radical derived from straight-chain alkane, which may be optionally interrupted by at least one heteroatom selected from O, S and N. Typically, alkylene groups herein will have from 1 to 24 carbon atoms (C₁-C₂₄-alkylene), preferably 1 to 18 carbon atoms (C₁-C₁₈-alkylene), more preferably 1 to 12 carbon atoms (C₁-C₁₂-alkylene). Examples of alkylene groups are especially methylene, ethylene, trimethylene, tetramethylene, pentamethylene, hexamethylene, heptamethylene, octamethylene, nonamethylene, decamethylene, undecamethylene, dodecamethylene, hexadecamethylene, octadecamethylene, etc.

The term “alkenylene” as used herein refers to unsaturated divalent radical derived from straight-chain alkene where any double bond is at internal position. Typically, alkenylene groups herein will have from 2 to 24 carbon atoms (C₂-C₂₄-alkenylene), preferably 2 to 18 carbon atoms (C₂-C₁₈-alkynelene), more preferably 2 to 12 carbon atoms (C₂-C₁₂-alkenylene). Examples of alkenylene groups are especially vinylene, 1,3-propenylene, 1,4-buta-2-enylene, 1,5-pent-2-enylene, 1,6-hex-3-enylene, etc.

The term “alkyl” as used herein and in the alkyl moieties of alkoxy, alkylthio, alkylamino, dialkylamino and the like refers to saturated straight-chain or branched hydrocarbyl having usually 1 to 18 carbon atoms (C₁-C₁₈-alkyl), preferably 1 to 12 carbon atoms (C₁-C₁₂-alkyl), more preferably 1 to 8 carbon atoms (C₁-C₈-alkyl) or 1 to 4 carbon atoms (C₁-C₄-alkyl). Examples of alkyl groups are especially methyl, ethyl, n-propyl, isopropyl, n-butyl, isobutyl, sec-butyl, tert-butyl, n-pentyl, 1-methylbutyl, 1-ethylpropyl, neo-pentyl, n-hexyl, 1-methylpentyl, 2-methylpentyl, 1-ethylbutyl, 2-ethylbutyl, n-heptyl, 1-methylhexyl, 2-methylhexyl, 1-ethylpentyl, 1-propylbutyl, 2-ethylpentyl, n-octyl, 1-methylheptyl, 2-methylheptyl, 1-ethylhexyl, 2-ethylhexyl, 1-propylpentyl, 2-propylpentyl, n-nonyl, etc.

The term “alkoxy” as used herein refers to an alkyl that is attached via an oxygen atom, which may be represented by —O-alkyl, where alkyl is as defined above.

The term “alkylthio” as used herein refers to an alkyl that is attached via a sulfur atom, which may be represented by —S-alkyl, where alkyl is as defined above.

The term “alkylamino” and “di(alkyl)amino” as used herein refer to an amino (—NH₂) with the hydrogen atoms being replaced with one or two alkyl groups respectively, where alkyl is as defined above.

The term “alkylidene” as used herein refers to unsaturated divalent radical derived from alkane with both valencies on the same carbon atom, which may be represented by *═CRₐR_{b} where the asterisk (*) denotes the position where the alkylidene group is attached to the remainder, and Rₐ and R_{b} respectively donates H or alkyl. Typically, alkylidene groups herein will have from 1 to 6 carbon atoms (C₁-C₆-alkylidene), preferably 1 to 4 carbon atoms (C₁-C₄-alkylidene). Examples of alkylidene groups are especially methylidene, ethylidene, propylidene, etc.

The term “halogen” as used herein refers to fluorine, bromine, chlorine and iodine.

In a particular embodiment, the structural units from lysine monomer comprised in the carboxymethylated lysine-based polymer according to the present invention may be represented by

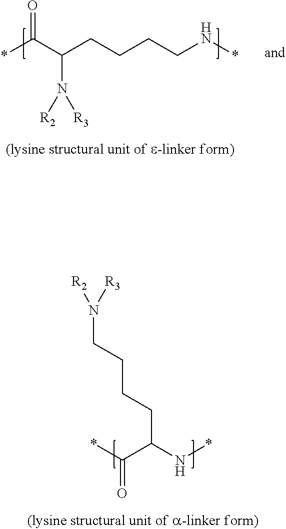

wherein
R₂ and R₃ independently from each other is H, COOH or COOM_{1/x} in which M is a cation and x is the valency of the cation, particularly M being an alkali metal cation or a quaternary ammonium cation; and
* denotes the position where the structural unit is attached to any other structural units by an amide linkage.

It will be understood that each lysine structural unit as described above may be linked to a lysine structural unit of the same linkage form to constitute a polymeric block, linked to a structural unit of the other linkage form or to a polymeric block consisting of lysine structural units of the other linkage form, or linked to a dicarboxylic acid structural unit; and each lysine structural unit may be linked to two same or different structure units.

The dicarboxylic acid structural units comprised in the carboxymethylated lysine-based polymer according to the present invention may for example be represented by formula (II)

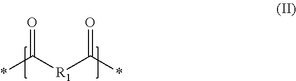

wherein
R₁ is as defined herein above for the formula (I),
* denotes the position where the structural unit is attached to any other structural units by an amide linkage.

It will be understood that each structural unit of formula (II) as described above may be linked to two lysine structural units of the same or different linkages.

It will also be understood that the dicarboxylic acid structural units comprised in the carboxymethylated lysine-based polymer according to the present invention may also be in any other possible form when R₁ is a hydrocarbylene substituted with an amino group (NH₂). The amino substitute is reactive to the carboxyl groups contained in the lysine monomer and dicarboxylic acid and may form corresponding amide linkage.

In a particular embodiment, the carboxymethylated lysine-based polymer according to the present invention comprises structural units (B) from at least one dicarboxylic acid of formula (I) or amide-forming derivative thereof wherein R₁ is a direct bond or an aliphatic linear C₁-C₂₄-hydrocarbylene, which is unsubstituted or substituted with at least one group selected from unsubstituted or substituted C₁-C₁₈-alkyl, unsubstituted or substituted C₁-C₁₈-alkoxy, unsubstituted or substituted C₁-C₁₈-alkylthio, unsubstituted or substituted C₁-C₁₈-alkylamino, di(C₁-C₁₈-alkyl)amino, C₁-C₆-alkylidene, hydroxyl, mercapto, amino and halogen.

In a preferable embodiment, the carboxymethylated lysine-based polymer according to the present invention comprises structural units (B) from at least one dicarboxylic acid of formula (I) or amide-forming derivative thereof wherein R₁ is a direct bond or an aliphatic linear C₁-C₁₈-hydrocarbylene, which is unsubstituted or substituted with at least one group selected from unsubstituted or substituted C₁-C₁₂-alkyl, unsubstituted or substituted C₁-C₁₂-alkoxy, unsubstituted or substituted C₁-C₁₂-alkylthio, unsubstituted or substituted C₁-C₁₂-alkylamino, di(C₁-C₁₂-alkyl)amino, C₁-C₄-alkylidene, hydroxyl, mercapto, amino and halogen.

In a more preferable embodiment, the carboxymethylated lysine-based polymer according to the present invention comprises structural units (B) from at least one dicarboxylic acid of formula (I) or amide-forming derivative thereof wherein R₁ is a direct bond or an aliphatic linear C₁-C₁₂-hydrocarbylene, which is unsubstituted or substituted with at least one group selected from unsubstituted or substituted C₁-C₈-alkyl, unsubstituted or substituted C₁-C₈-alkoxy, unsubstituted or substituted C₁-C₈-alkylthio, unsubstituted or substituted C₁-C₈-alkylamino, di(C₁-C₈-alkyl)amino, C₁-C₄-alkylidene, hydroxyl, mercapto, amino and halogen.

In a further preferable embodiment, the carboxymethylated lysine-based polymer according to the present invention comprises structural units (B) from at least one dicarboxylic acid of formula (I) or amide-forming derivative thereof wherein R₁ is a direct bond, C₁-C₁₂-alkylene or C₂-C₁₂-alkenylene, which are unsubstituted or substituted with at least one group selected from unsubstituted or substituted C₁-C₄-alkyl, unsubstituted or substituted C₁-C₄-alkoxy, unsubstituted or substituted C₁-C₄-alkylthio, unsubstituted or substituted C₁-C₄-alkylamino, di(C₁-C₄-alkyl)amino, C₁-C₄-alkylidene, hydroxyl, mercapto, amino and halogen.

In a still preferable embodiment, the carboxymethylated lysine-based polymer according to the present invention comprises structural units (B) from at least one dicarboxylic acid of formula (I) or amide-forming derivative thereof wherein R₁ is a direct bond, C₁-C₁₂-alkylene or C₂-C₁₂-alkenylene, which are unsubstituted or substituted with at least one group selected from unsubstituted or substituted C₁-C₄-alkyl, C₁-C₄-alkylidene, hydroxyl, mercapto and amino.

In most preferable embodiment, the carboxymethylated lysine-based polymer according to the present invention comprises structural units (B) from at least one dicarboxylic acid of formula (I) or amide-forming derivative thereof wherein R₁ is a direct bond, C₁-C₁₂-alkylene or C₂-C₁₂-alkenylene, which are unsubstituted or substituted with at least one group selected from unsubstituted or substituted C₁-C₄-alkyl, C₁-C₂-alkylidene, hydroxyl and amino.

Particularly, the carboxymethylated lysine-based polymer according to the present invention comprises structural units (B) from at least one of oxalic acid, malonic acid, succinic acid, maleic acid and fumaric acid, tartaric acid, aspartic acid, glutaric acid, itaconic acid, glutamic acid, adipic acid, pimelic acid, suberic acid, azelaic acid, sebacic acid, undecanedioic acid and dodecanedioic acid.

Preferably, the carboxymethylated lysine-based polymer according to the present invention comprises
(A) 70 to 97 mol % of the lysine structural units; and
(B) 3 to 30 mol % of the dicarboxylic acid structural units.

More preferably, the carboxymethylated lysine-based polymer according to the present invention comprises:
(A) 75 to 97 mol % of the lysine structural units; and
(B) 4 to 25 mol % of the dicarboxylic acid structural units.

Most preferably, the carboxymethylated lysine-based polymer according to the present invention comprises
(A) 75 to 95 mol % of the lysine structural units; and
(B) 5 to 25 mol % of the dicarboxylic acid structural units.

The carboxymethylated lysine-based polymer according to the present invention has a degree of modification (DM) by carboxymethylation of at least 20%, particularly at least 30%, preferably at least 50%, still preferably at least 70%, more preferably at least 80%. Herein, the degree of modification (DM) is defined theoretically in accordance with the following equation:

$$DM = \frac{( moles of carboxymethyl groups )}{\begin{matrix}2 \times ( moles of structural units of lysine + \\ moles of dicarboxylic acid structural units having an amino \\ group when present )\end{matrix}} \times 100 \%$$

Measurement of DM may be carried out by hydrolyzing the carboxymethylated lysine-based polymer and determining the moles of carboxymethyl groups, the moles of structural units of lysine, and the moles of dicarboxylic acid structural units having an amino group when present according to the resonance signals assigned to respective protons in the hydrolysis products as measured by ¹H NMR in D₂O. It will be understood that the measured DM value may not be exactly the same as the theoretical value due to the limitation of the measurement method.

Preferably, the carboxymethylated lysine-based polymer according to the present invention is prepared from a lysine-based polymer having a K-value in the range of 8 to 20, more preferably 9 to 15, and most preferably 9.5 to 13, as determined with 1 wt % solution of respective lysine-based polymer in water at 23° C. according to DIN ISO 1628-1. The K-value is often referred to as intrinsic viscosity and is an indirect measure of molecular weight of polymers.

The carboxymethylated lysine-based polymer according to the present invention has a number average molecular weight (Mn) in the range of 400 to 10,000 g/mol, preferably 600 to 8,500 g/mol, more preferably 750 to 7,000 g/mol, and/or has a weight average molecular weight (Mw) in the range of 500 to 3,500 g/mol, preferably 650 to 3,000 g/mol, more preferably 800 to 2,250 g/mol. The average molecular weights may be measured in accordance with the methods described herein below.

It is preferred that the carboxymethylated lysine-based polymer according to the present invention has a degree of modification (DM) by carboxymethylation of at least 30%, preferably at least 50%, still preferably at least 70%, and has a number average molecular weight (Mn) in the range of 600 to 8,500 g/mol, more preferably 750 to 7,000 g/mol and/or a weight average molecular weight (Mw) in the range of preferably 650 to 3,000 g/mol, more preferably 800 to 2,250 g/mol.

Particularly, the carboxymethylated lysine-based polymer according to the present invention has a degree of modification (DM) by carboxymethylation of at least 50%, still preferably at least 70%, and has a number average molecular weight (Mn) in the range of 750 to 7,000 g/mol and/or a weight average molecular weight (Mw) in the range of 800 to 2,250 g/mol.

### <Process for Preparing the Carboxymethylated Lysine-Based Polymer>

There is no particular restriction to the process for preparing the carboxymethylated lysine-based polymer according to the present invention. Generally, the carboxymethylated lysine-based polymer according to the present invention may be prepared by a process including thermal polycondensation of lysine and the at least one dicarboxylic acid or amide-forming derivative thereof to provide a lysine-based polymer and subsequent carboxymethylation of the lysine-based polymer.

In a particular embodiment, the present invention relates to a process for preparing a carboxymethylated lysine-based polymer, which comprises
thermal polycondensation of monomers comprising
(A) 60 to 95 mol % of lysine monomer,
(B) 5 to 40 mol % of at least one dicarboxylic acid of formula (I) or amide-forming derivative thereof

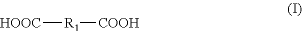

wherein
R₁ is a direct bond or an aliphatic linear hydrocarbylene, which is unsubstituted or substituted with at least one group selected from unsubstituted or substituted alkyl, unsubstituted or substituted alkoxy, unsubstituted or substituted alkylthio, unsubstituted or substituted alkylamino, di(alkyl)amino, alkylidene, hydroxyl, mercapto, amino and halogen,
to obtain a lysine-based polymer, and
carboxymethylation of the lysine-based polymer.

Preferably, the process according to the present invention comprises thermal polycondensation of monomers comprising
(A) 70 to 90 mol % of lysine monomer; and
(B) 10 to 30 mol % of at least one dicarboxylic acid of formula (I) or amide-forming derivative thereof.

More preferably, the process according to the present invention comprises thermal polycondensation of monomers comprising
(A) 75 to 90 mol % of lysine monomer; and
(B) 10 to 25 mol % of at least one dicarboxylic acid of formula (I) or amide-forming derivative thereof.

Most preferably, the process according to the present invention comprises thermal polycondensation of monomers comprising
(A) 80 to 90 mol % of lysine monomer; and
(B) 10 to 20 mol % of at least one dicarboxylic acid of formula (I) or amide-forming derivative thereof.

The lysine monomer may for example be in form of lysine zwitterionic free base, lysine hydrochloride, and/or lysine hydrate.

Suitable amide-forming derivatives of the dicarboxylic acid of formula (I) include but are not limited to mono- and di-ester, anhydride, mono- and di-amide and acid halide thereof.

In a further particular embodiment, R₁ in formula (I) is a direct bond or an aliphatic linear C₁-C₂₄-hydrocarbylene, which is unsubstituted or substituted with at least one group selected from unsubstituted or substituted C₁-C₁₈-alkyl, unsubstituted or substituted C₁-C₁₈-alkoxy, unsubstituted or substituted C₁-C₁₈-alkylthio, unsubstituted or substituted C₁-C₁₈-alkylamino, di(C₁-C₁₈-alkyl)amino, C₂-C₆-alkylidene, hydroxyl, mercapto, amino and halogen.

In a preferable embodiment, R₁ in formula (I) is a direct bond or an aliphatic linear C₁-C₁₈-hydrocarbylene, which is unsubstituted or substituted with at least one group selected from unsubstituted or substituted C₁-C₁₂-alkyl, unsubstituted or substituted C₁-C₁₂-alkoxy, unsubstituted or substituted C₁-C₁₂-alkylthio, unsubstituted or substituted C₁-C₁₂-alkylamino, di(C₁-C₁₂-alkyl)amino, C₁-C₄-alkylidene, hydroxyl, mercapto, amino and halogen.

In a more preferable embodiment, R₁ in formula (I) is a direct bond or an aliphatic linear C₁-C₁₂-hydrocarbylene, which is unsubstituted or substituted with at least one group selected from unsubstituted or substituted C₁-C₈-alkyl, unsubstituted or substituted C₁-C₈-alkoxy, unsubstituted or substituted C₁-C₈-alkylthio, unsubstituted or substituted C₁-C₈-alkylamino, di(C₁-C₈-alkyl)amino, C₁-C₄-alkylidene, hydroxyl, mercapto, amino and halogen.

In a further preferable embodiment, R₁ in formula (I) is a direct bond, C₁-C₁₂-alkylene or C₂-C₁₂-alkenylene which are unsubstituted or substituted with at least one group selected from unsubstituted or substituted C₁-C₄-alkyl, unsubstituted or substituted C₁-C₄-alkoxy, unsubstituted or substituted C₁-C₄-alkylthio, unsubstituted or substituted C₁-C₄-alkylamino, di(C₁-C₄-alkyl)amino, C₁-C₄-alkylidene, hydroxyl, mercapto, amino and halogen.

In a still preferable embodiment, R₁ in formula (I) is a direct bond, C₁-C₁₂-alkylene or C₂-C₁₂-alkenylene, which are unsubstituted or substituted with at least one group selected from unsubstituted or substituted C₁-C₄-alkyl C₁-C₄-alkylidene, hydroxyl, mercapto and amino.

In most preferable embodiment, R₁ in formula (I) is a direct bond, C₁-C₁₂-alkylene or C₂-C₁₂-alkenylene which are unsubstituted or substituted with at least one group selected from unsubstituted or substituted C₁-C₄-alkyl, C₁-C₂-alkylidene, hydroxyl and amino.

Particularly, the at least one dicarboxylic acid of formula (I) is selected from oxalic acid, malonic acid, succinic acid, maleic acid and fumaric acid, tartaric acid, aspartic acid, glutaric acid, itaconic acid, glutamic acid, adipic acid, pimelic acid, suberic acid, azelaic acid, sebacic acid, undecanedioic acid and dodecanedioic acid.

The thermal polycondensation of a lysine monomer and a dicarboxylic acid of formula (I) or amide-forming derivative thereof may be carried out via known processes.

Preferably, the lysine-based polymer as obtained has a K-value in the range of 8 to 20, more preferably 9 to 15, and most preferably 9.5 to 13, as determined with 1 wt % solution of respective lysine-based polymer in water at 23° C. according to DIN ISO 1628-1.

The carboxymethylation of the lysine-based polymer may also be carried out via known processes for carboxymethylation of amino groups. For example, the carboxymethylation may be carried out simply via a carboxymethylation agent, such as iodioacetic acid as described in “Preparation and properties of poly(N^{ε},N^{ε}-dicarboxymethyl-L-lysine)”, Kazuo Uehara et al., Polymer, 1979, Vol 20, 670-674, sodium chloroacetate as described in U.S. Pat. No. 2,860,164A, and the like. Alternatively, the carboxymethylation may be carried out via reaction of the amino groups with formaldehyde and hydrogen cyanide or sodium cyanide under respective conditions as described in U.S. Pat. No. 2,860,164A.

The carboxymethylated lysine-based polymer obtainable or obtained from the process according to the present invention has a degree of modification (DM) by carboxymethylation of at least 20%, particularly at least 30%, preferably at least 50%, still preferably at least 70%, more preferably at least 80%.

The carboxymethylated lysine-based polymer obtainable or obtained from the process according to the present invention has a number average molecular weight (Mn) in the range of 400 to 10,000 g/mol, preferably 600 to 8,500 g/mol, more preferably 750 to 7,000 g/mol, and/or has a weight average molecular weight (Mw) in the range of 500 to 3,500 g/mol, preferably 650 to 3,000 g/mol, more preferably 800 to 2,250 g/mol.

It is preferred that the carboxymethylated lysine-based polymer obtainable or obtained from the process according to the present invention has a degree of modification (DM) by carboxymethylation of at least 30%, preferably at least 50%, still preferably at least 70%, and has a number average molecular weight (Mn) in the range of 600 to 8,500 g/mol, more preferably 750 to 7,000 g/mol and/or a weight average molecular weight (Mw) in the range of preferably 650 to 3,000 g/mol, more preferably 800 to 2,250 g/mol.

Particularly, the carboxymethylated lysine-based polymer obtainable or obtained from the process according to the present invention may has a degree of modification (DM) by carboxymethylation of at least 50%, still preferably at least 70%, and has a number average molecular weight (Mn) in the range of 750 to 7,000 g/mol and/or a weight average molecular weight (Mw) in the range of 800 to 2,250 g/mol.

It has been found that the carboxymethylated lysine-based polymers according to the present invention are useful as a dispersing and/or chelating agent in detergent compositions and peroxy bleaching compositions.

### <Detergent Compositions>

According to the present invention, the detergent composition may be any compositions comprising a surfactant or a surfactant mixture to provide cleansing efficacy. Particularly, the detergent composition is a laundry detergent composition or a detergent composition for cleaners. The term “detergent composition for cleaners” includes compositions for cleaners for home care and for industrial or institutional applications. Particularly, the detergent composition for cleaners includes compositions for dishwashing, especially hand dishwashing and automatic dishwashing and ware-washing, and compositions for hard surface cleaning such as, but not limited to compositions for bathroom cleaning, kitchen cleaning, floor cleaning, descaling of pipes, window cleaning, car cleaning including truck cleaning, furthermore, open plant cleaning, cleaning-in-place, metal cleaning, disinfectant cleaning, farm cleaning, high pressure cleaning, but not laundry detergent compositions.

There is no restriction to the formulation of the detergent composition. The carboxymethylated lysine-based polymer according to the present invention are useful for any conventional formulations of detergent composition such as laundry detergent composition or detergent composition for cleaners. It is to be understood that the carboxymethylated lysine-based polymer according to the present invention may be used in the detergent compositions in addition to or in place of the chelating agent and/or dispersing agent which would otherwise be comprised in a conventional formulation of the detergent composition.

In some embodiments of the present invention, the laundry detergent composition comprises the carboxymethylated lysine-based polymer according to the present invention in an amount of 0.5 to 30%, preferably 1 to 25%, and more preferably 1 to 15% by weight, for example 1 to 10% by weight based on the total solid content of the detergent composition.

In some other embodiments of the present invention, the detergent composition for cleaners comprises the carboxymethylated lysine-based polymer according to the present invention in an amount of 0.5 to 30%, preferably 1 to 20%, more preferably 1 to 10% by weight based on the total solid content of the detergent composition.

As the essential component providing the cleansing efficacy for the detergent composition, at least one of cationic, anionic, nonionic and amphoteric surfactants may be comprised depending on the specific applications and desired performances of the detergent composition.

### Nonionic Surfactants

Useful nonionic surfactants may include, but are not limited to condensation products of (1) alcohols with ethylene oxide, of (2) alcohols with ethylene oxide and a further alkylene oxide, of (3) polypropylene glycol with ethylene oxide or of (4) ethylene oxide with a reaction product of ethylenediamine and propylene oxide, fatty acid amides, and semipolar nonionic surfactants.

Condensation product of alcohols with ethylene oxide derives for example from alcohols having a C to C₂₂-alkyl group, preferably a C₁₀ to C₁₈-alkyl group, which may be linear or branched, primary or secondary. The alcohols are condensed with about 1 to 25 mol and preferably with about 3 to 18 moles of ethylene oxide per mole of alcohol.

Condensation products of alcohols with ethylene oxide and a further alkylene oxide may be constructed according to the scheme R—O-EO-AO or R—O-AO-EO, where R is a primary or secondary, branched or linear C₈ to C₂₂-alkyl group, preferably a C₁₀ to C₁₈-alkyl group, EO is ethylene oxide and AO comprises an alkylene oxide, preferably propylene oxide, butylene oxide or pentylene oxide.

Condensation products of polypropylene glycol with ethylene oxide comprise a hydrophobic moiety preferably having a molecular weight of from about 1,500 to about 1,800. The addition of up to about 40 moles of ethylene oxide onto this hydrophobic moiety leads to amphiphilic compounds.

Condensation products of ethylene oxide with a reaction product of ethylenediamine and propylene oxide comprises a hydrophobic moiety consisting of the reaction product of ethylenediamine and propylene oxide and generally having a molecular weight of from about 2,500 to about 3,000. Ethylene oxide is added up to a content, based on the hydrophobic unit, of about 40% to about 80% by weight of polyoxyethylene and a molecular weight of from about 5,000 to about 11,000.

Fatty acid amides may be those of following formula

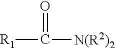

where
R¹ is an alkyl radical having 7 to 21 and preferably 9 to 17 carbon atoms, and
R², independently from each other, is hydrogen, C₁ to C₄-alkyl, C₁ to C₄-hydroxyalkyl or (C₂H₄O)ₓH where x varies from 1 to 3.

Preference is given to C₈ to C₂₀-fatty acid amides such as monoethanolamides, diethanolamides and diisopropanolamides.

As the semipolar nonionic surfactants, water-soluble amine oxides, water-soluble phosphine oxides and water-soluble sulfoxides each having at least one C₈ to C₁₈-alkyl group, preferably C₁₀ to C₁₄-alkyl group may be mentioned. Preference is given to C₁₀-C₁₂-alkoxyethyldihydroxyethylamine oxides.

In some embodiment, weakly foaming or low-foam nonionic surfactants are preferable, for example in automatic dishwashing compositions. Particularly, following nonionic surfactants of the formulae (I), (II) and (III) may be mentioned,

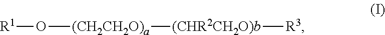

where
R¹ is a linear or branched C₈ to C₂₂-alkyl radical,
R² and R³, independently of one another, are hydrogen or a linear or branched C₁ to C₁₀-alkyl radical, where R² is preferably methyl, and
a and b, independently of one another, are 0 to 300;

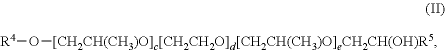

where
R⁴ is a linear or branched aliphatic C₄ to C₂₂-hydrocarbyl radical or mixtures thereof,
R⁵ is a linear or branched C₂ to C₂₆-hydrocarbyl radical or mixtures thereof, c and e are values between 0 and 40, and
d is a value of at least 15;

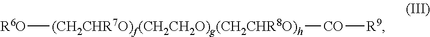

where
R⁶ is a branched or unbranched C₈ to C₁₆-alkyl radical,
R⁷, R⁸, independently of one another, are H or a branched or unbranched C₁ to C₅-alkyl radical,
R⁹ is an unbranched C₅ to C₁₇-alkyl radical,
f, h, independently of one another, are a number from 1 to 5, and
g is a number from 13 to 35.

The surfactants of the formulae (I), (II) and (III) can either be random copolymers or block copolymers, preferably in the form of block copolymers, as described in U.S. Pat. No. 9,796,951B2, which will be incorporated herein by reference.

### Anionic Surfactants

Useful anionic surfactants may include but are not limited to alkenyl- or alkyl benzenesulfonates, alkanesulfonates, olefinsulfonates, alkyl ester sulfonates, alkyl sulfates, alkyl ether sulfates, alkyl carboxylates (soap). The counter-ions present are alkali metal cations, preferably sodium or potassium, alkaline earth metal cations, for example calcium or magnesium, and also ammonium and substituted ammonium compounds, for example mono-, di- or triethanol ammonium cations and mixtures of the aforementioned cations therefrom.

Alkenyl- or alkyl benzenesulfonates may comprise a branched or linear, optionally hydroxyl-substituted alkenyl or alkyl group, preferably linear C₉ to C₂₅-alkyl group.

Alkane sulfonates are available on a large industrial scale in the form of secondary alkanesulfonates where the sulfo group is attached to a secondary carbon atom of the alkyl moiety. The alkyl can in principle be saturated, unsaturated, branched or linear and optionally hydroxyl substituted. Preferred secondary alkane sulfonates comprise linear C₉ to C₂₅-alkyl radicals, preferably C₁₀ to C₂₀-alkyl radicals and more preferably C₁₂ to C₁₈-alkyl radicals.

Olefinsulfonates are obtained by sulfonation of C₈ to C₂₄ and preferably C₁₄ to C₁₆-α-olefins with sulfur trioxide and subsequent neutralization. Owing to their production process, these olefinsulfonates may comprise minor amounts of hydroxy alkanesulfonates and alkanedisulfonates.

Alkyl ester sulfonates derive for example from linear ester of C to C₂₀-carboxylic acids, i.e., fatty acids, which are sulfonated with sulfur trioxide. Compounds of following formula are preferred

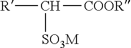

where
R′ is a C₈ to C₂₀-alkyl radical, preferably C₁₀ to C₁₆-alkyl and R″ is a C₁ to C₆-alkyl radical, preferably a methyl, ethyl or isopropyl group. Particular preference is given to methyl ester sulfonates where R¹ is C₁₀ to C₁₆-alkyl.

Alkyl sulfates are surfactants of the formula ROSO₃M′, where R is C₁₀ to C₂₄-alkyl and preferably C₁₂ to C₁₈-alkyl. M′ is a counter-ion as described at the beginning for anionic surfactants.

Alkyl ether sulfates have the general structure RO(A)ₘSO₃M, where R is a C₁₀ to C₂₄-alkyl and preferably C₁₂ to C₁₈-alkyl radical, where A is an alkoxy unit, preferably ethoxy and m is a value from about 0.5 to about 6, preferably between about 1 and about 3, and M is a cation, for example sodium, potassium, calcium, magnesium, ammonium or a substituted ammonium cation.

Alkyl carboxylates are generally known by the term “soap”. Soap can be manufactured on the basis of saturated or unsaturated, preferably natural, linear C₈ to C₁₈-fatty acid. Saturated fatty acid soaps include for example the salts of lauric acid, myristic acid, palmitic acid, stearic acid, hydrogenated erucic acid and behenic acid, and in particular soap mixtures derived from natural fatty acids, for example coconut, palm kernel or tallow fatty acids. Known alkenylsuccinic acid salts may also be used together with soap or as substitutes for soap.

Further anionic surfactant are salts of acylamino carboxylic acids, acyl sarcosinates, fatty acid-protein condensation products obtained by reaction of fatty acid chlorides with oligopeptides; salts of alkylsulfamido carboxylic acids; salts of alkyl and alkylary ether carboxylic acids; sulfonated polycarboxylic acids, alkyl and alkenyl glycerol sulfates, such as oleyl glycerol sulfates, alkylphenol ether sulfates, alkyl phosphates, alkyl ether phosphates, isethionates, such as acyl isethionates, N-acyltaurides, alkyl succinates, sulfosuccinates, monoesters of sulfosuccinates (particularly saturated and unsaturated C₁₂ to C₁₈-monoesters) and diesters of sulfosuccinates (particularly saturated and unsaturated C₁₂ to C₁₈-diesters), sulfates of alkylpolysaccharides such as sulfates of alkylpolyglycosides and alkypolysaccharides such as sulfates of alkylpolyglycosides and alkyl polyethoxy carboxylates such as those of the formula RO(CH₂CH₂)ₖCH₂COOM, where R is C₈ to C₂₂-alkyl, k is a number from 0 to 10 and M is a cation.

### Cationic Surfactants

Useful cationic surfactants may be substituted or unsubstituted straight chain or branched quaternary ammonium salts of R¹N(CH₃)₃⁺X⁻, R¹R²N(CH₃)₂⁺X⁻, R¹R²R³N(CH₃)⁺X⁻ or R¹R²R³R⁴N⁺X⁻, where R¹, R², R³ and R⁴ independently from each other are unsubstituted C₈ to C₂₄-alkyl and preferably C₈ to C₁₈-alkyl, hydroxylalkyl having 1 to 4 carbon atoms, phenyl, C₂ to C₁₈-alkenyl, C₇ to C₂₄-aralkyl, (C₂H₄O)ₓH where x is from about 1 to about 3, the alkyl radical optionally comprising one or more ester groups, and X is a suitable anion. Useful cationic surfactants may also be cyclic quaternary ammonium salts.

### Amphoteric/Zwitterionic Surfactants

Useful amphoteric surfactants may be aliphatic derivatives of secondary or tertiary amines, or aliphatic derivatives of heterocyclic secondary and tertiary amines, in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof. Examples of the species as the amphoteric surfactants are known in the art, for example from WO2005095569A1.

Useful zwitterionic surfactants may be derivatives of secondary and tertiary amines, derivatives of heterocyclic secondary and tertiary amines, or derivatives of quaternary ammonium, quaternary phosphonium or tertiary sulfonium compounds. Suitable Examples of zwitterionic surfactants include, but are not limited to, betaines such as alkylbetaines and alkylamide betaines, such as N-alkyl-N,N-dimethyl-N-carboxymethylbetaines, N-(alkylamidopropyl)-N,N-dimethyl-N-carboxymethylbetaines, alkyldipolyethoxybetains, alkylamine oxides, and sulfo and hydroxy betaines such as N-alkyl-N,N-dimethylammino-1-propane sulfonate, each having a linear or branched C₈ to C₂₂-alkyl, preferably C₈ to C₁₈-alkyl radical and more preferably C₁₂ to C₁₈-alkyl.

In an exemplary embodiment of the present invention, a laundry detergent composition may comprise 0.1 to 80% by weight of at least one surfactant selected from anionic surfactants, amphoteric surfactants and nonionic surfactants, based on the total solid content of the detergent composition. Some preferred laundry detergent composition of the present invention may contain at least one anionic or non-ionic surfactant.

In another exemplary embodiment of the present invention, a detergent composition for cleaners may comprise 0.1 to 80% by weight of at least one surfactant selected from anionic surfactants, amphoteric surfactants and nonionic surfactants, based on the total solid content of the detergent composition. Some preferred detergent composition for cleaners of the present invention may contain at least one anionic or non-ionic surfactant.

### Auxiliaries

The detergent composition may further comprise customary auxiliaries which serve to modify the performance characteristics of the detergent composition.

Suitable auxiliaries for detergent compositions may include but are not limited to builder such as complexing agent other than carboxymethylated lysine-based polymer according to the present invention, ion exchange agent and precipitating agent, bleaching agent, bleach activators, corrosion inhibitor, foam boosters, antifoams, dyes, fillers, color care agent, optical brightener, disinfectant, alkalis, antioxidant, thickener, perfume, solvent, solubilizer, softener and antistatic agent. By way of example, some auxiliaries will be described hereinbelow.

Generally, the detergent composition may comprise at least one builder selected from organic and inorganic builders. Examples of suitable inorganic builders are sodium sulfate or sodium carbonate or silicates, in particular sodium disilicate and sodium metasilicate, zeolites, sheet silicates, in particular those of the formula α-Na₂Si₂O₅, β-Na₂Si₂O₅, and δ-Na₂Si₂O₅. Examples of suitable organic builders are fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, and polymeric builders, for example polycarboxylates and polyaspartic acid.

The detergent composition may comprise the builder, for example, in a total amount of 10 to 70% by weight, preferably up to 50% by weight, based on the total solid content of the detergent composition. In the context of the present invention, the carboxymethylated lysine-based polymer according to the present invention are not counted as the builder.

The detergent composition may comprise at least one antifoam, selected for example from silicone oils and paraffin oils. The antifoams may be in a total amount of 0.05 to 0.5% by weight, based on the total solid content of the detergent composition.

The detergent composition may comprise at least one bleaching agent. The bleaching agent may be selected from chlorine bleach and peroxide bleach.

Peroxide bleach may be selected from inorganic peroxide bleach and organic peroxide bleach. Preferred inorganic peroxide bleaches are selected from alkali metal percarbonate, alkali metal perborate and alkali metal persulfate. In solid detergent compositions for hard surface cleaning and in solid laundry detergent compositions, alkali metal percarbonates, especially sodium percarbonates, are preferably used in coated form. Such coatings may be of organic or inorganic nature. Examples are glycerol, sodium sulfate, silicate, sodium carbonate, and combinations thereof, for example combinations of sodium carbonate and sodium sulfate. Examples of organic peroxide bleaching agents are percarboxylic acids.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate. The laundry detergent composition and the detergent compositions for cleaners may comprise the chlorine-containing bleach, for example, in a total amount of from 3 to 10% by weight, based on the total solid content of the detergent composition.

The detergent composition may also comprise at least one bleach activator for example N-methylmorpholinium-acetonitrile salts (“MMA salts”), tri-methylammonium acetonitrile salts, N-acylimides such as N-nonanoylsuccinimide, 1,5-diacetyl-2,2-dioxohexahydro-1,3,5-triazine (“DADHT”) or nitrile quats (trimethylammonium acetonitrile salts). Further examples of bleach activators are tetraacetylethylenediamine (TAED) and tetraacetylhexylenediamine.

The detergent composition may comprise at least one corrosion inhibitor. Examples of suitable corrosion inhibitors are triazoles, in particular benzotriazoles, bisbenzotriazoles, aminotriazoles, alkylaminotriazoles, phenol derivatives such as hydroquinone, pyrocatechol, hydroxyhydroquinone, gallic acid, phloroglucinol or pyrogallol. The detergent composition may comprise the corrosion inhibitor in a total amount of 0.1 to 1.5% by weight, based on the total solid content of the detergent composition.

The detergent composition may also comprise at least one enzyme. Examples of enzymes are lipases, hydrolases, amylases, proteases, cellulases, esterases, pectinases, lactases and peroxidases, particularly proteases. The enzyme may be comprised in the detergent composition, particularly the laundry detergent composition and the detergent composition for cleaners in an amount of up to 5% by weight, for example 0.1 to 3% by weight, or 0.1 to 2% by weight, or even 0.1 to 1% by weight based on the total solid content of the detergent composition. The enzyme may be stabilized, for example with the sodium salt of at least one C₁ to C₃-carboxylic acid or C₄ to C₁₀-dicarboxylic acid.

Suitable species and dosages of the conventional auxiliaries for the detergent composition, particularly laundry detergent composition and detergent composition for cleaners, are well-known in the art and may be found in for example WO 2017174413A1, WO 2015187757A1, U.S. Pat. No. 9,796,951B2 and US20190136152A1.

### <Peroxy Bleaching Compositions>

Peroxy bleaching agents are widely used in various processes such as textile whitening, cellulosic fiber pulp whitening, hair decoloring and surface disinfection, due to the strong oxidation ability of peroxides. It is known that peroxides are generally sensitive to heavy metal ions such as Fe, Cu, Mn, Ni, Co, Zn, Pb and Cd ions since heavy metal ions could catalyze the decomposition of peroxides. Even small amount of heavy metal ions may inevitably have an adverse impact on the bleaching effect.

As a conventional measure to stabilize peroxides such as hydrogen peroxide against heavy metal ions, an additive which could chelating or complexing the heavy metal ions (e.g. EDTA, DTPA, NTA) is often used in peroxy bleaching compositions comprising hydrogen peroxide or a precursor of hydrogen peroxide which could generate hydrogen peroxide during bleaching process.

It has been found that the carboxymethylated lysine-based polymers according to the present invention are useful as stabilizer of peroxy bleaching agent. Particularly, the peroxy bleaching agent may be those conventionally used for bleaching cellulosic fibrous materials such as wood, cotton, linen, jute and other materials of a cellulosic nature, which may be in form of individual fibers (e.g. wood pulp or cotton fiber), as well as yarns, tows, webs, fabrics (woven or non-woven) and other aggregates of such fibers, and for bleaching synthetic textiles including polyamides, viscose, rayon, and polyesters.

In an embodiment of the present invention, the carboxymethylated lysine-based polymers according to the present invention are comprised as a stabilizer in a peroxy bleaching composition for bleaching cellulose fiber pulps. Cellulose fiber pulps generally comprising a certain amount of heavy metal ions such as Fe, Cu and Mn ions, which need to be masked such that the bleaching effect would not be impacted adversely.

In a particular embodiment, the peroxy bleaching composition for bleaching cellulose fiber pulps is in a form of aqueous hydrogen peroxide solution. The aqueous hydrogen peroxide solution generally comprises an inorganic alkali metal basic material, such as sodium hydroxide, sodium carbonate, sodium silicate and mixtures thereof. The inorganic alkali metal basic material was used to endow a desirable pH in the range of 7.5 to 12.5 to the aqueous hydrogen peroxide solution. The carboxymethylated lysine-based polymer may be comprised in an amount of 0.01 to 3% by weight, preferably 0.1 to 1% by weight in the aqueous hydrogen peroxide solution, based on the total weight of the solution.

In another particular embodiment, the carboxymethylated lysine-based polymers according to the present invention and the peroxide component are comprised separately in the peroxy bleaching composition for bleaching cellulose fiber pulps. In this embodiment, the carboxymethylated lysine-based polymer and the hydrogen peroxide are not mixed until both being incorporated into the cellulose fiber pulp to be bleached. The carboxymethylated lysine-based polymer may be incorporated into the cellulose fiber pulp in a dosage of 0.01 to 3% by weight, preferably 0.1 to 1% by weight, more preferably 0.2 to 0.8% by weight, based on the weight of the cellulose fiber pulps. The specific dosage of carboxymethylated lysine-based polymer may vary depending on the heavy metal contents of the pulp, hydrogen oxide dosage, bleaching process and the like. It is also desirable to use an inorganic alkali metal basic material, such as sodium hydroxide, sodium carbonate, sodium silicate and mixtures thereof such that the bleaching is carried out at a pH in the range of 7.5 to 12.5.

The following Examples are provided to illustrate the present invention, which however are not intended to limit the present invention.

### EXAMPLES

### Description of Materials Used in Examples

Polymer PA-1: Polyacrylic acid, sodium salt, aqueous solution, pH 8 (10%), solid content 40 wt %, Mw 4000 g/mol, commercially available from BASF
Polymer PA-2: Polyacrylic acid, sodium salt, aqueous solution, pH 8 (10%), solid content 45 wt %, Mw 1200 g/mol, commercially available from BASF
Copolymer CP-1: Copolymer of maleic acid and an olefin, sodium salt, aqueous solution, solid content 25 wt %, Mw 12,000 g/mol, commercially available from BASF
Modified PEI-1: Carboxymethylated polyethyleneimine, aqueous solution, solid content 40%, commercially available from BASF
Modified PEI-2: Ethoxylated polyethyleneimine, Mw 14,000 g/mol, wt % N: 18.19, commercially available from BASF
EDTA Liquid: Ethylenediaminetetraacetic acid, tetrasodium salt (EDTA-Na₄), active content 40 wt %, commercially available from BASF
MGDA Granules: Methylglycinediacetic acid, trisodium salt (MGDA-Na₃), granules, active content 85%, commercially available from BASF
MGDA Liquid: Methylglycinediacetic acid, trisodium salt (MGDA-Na₃), aqueous solution, active content 40%, commercially available from BASF
Anionic Surfactant AES: C₁₂C₁₄ fatty alcohol ether sulfate (2EO), sodium salt, commercially available from BASF
Anionic Surfactant DBS/LC: Linear C₁₀C₁₃-Alkyl Benzene Sulfonates, commercially available from BASF
Anionic Surfactant LDBS 55: linear n-C₁₀C₁₃-alkyl benzene sulfonate, sodium salt, active content 55%, commercially available from BASF
Non-ionic Surfactant AEO-1: Ethoxylated C₁₃C₁₅-oxo alcohol (7EO), commercially available from BASF
Non-ionic Surfactant AEO-2: Ethoxylated C₁₂C₁₄-fatty alcohol, (7EO), commercially available from BASF
Edenor® K12-18: Coco fatty acid, commercially available from Henkel
Protease: Blaze® Evity®150T, commercially available from Novozymes
Amylase: Stainzyme® Plus Evity® 12L, commercially available from Novozymes
White cotton fabric: wfk 10A, wfk 80A, wfk 12A from wfk Testgewebe GmbH, Brüggen, Deutschland; EMPA 221 from Swissatest Testmaterialien AG, Sankt Gallen, Schweiz; and T-shirt (Single-Jersey, S+Z, 100% cotton) from MRCreation, Goethestraße 86, 72461 Alzenau;
White polyester/cotton fabric: wfk 20A, commercially available from wfk Testgewebe GmbH, Brüggen, Deutschland
White polyester fabric: wfk 30A, commercially available from wfk Testgewebe GmbH, Brüggen, Deutschland
White polyamid fabric: EMPA 406, commercially available from Swissatest Testmaterialien AG, Sankt Gallen, Schweiz

### Soiled Fabrics:

EMPA 101 (Cotton soiled with carbon black and olive oil) commercially available from Swissatest Testmaterialien AG, Sankt Gallen, Schweiz
EMPA 125 (Cotton soiled with a mixture of oily components and pigments) commercially available from Swissatest Testmaterialien AG, Sankt Gallen, Schweiz
SBL 2004 (Cotton soiled with sebum) commercially available from wfk Testgewebe GmbH, Brüggen, Deutschland
wfk 10 PF (Cotton soiled with pigment/vegetable fat) commercially available from wfk Testgewebe GmbH, Brüggen, Deutschland
wfk 20 D (Polyester/Cotton soiled with sebum) commercially available from wfk Testgewebe GmbH, Brüggen, Deutschland
CFT C-S-10 (Cotton soiled with butter fat) commercially available from CFT, NL-Vlaardingen
CFT C-S-62 (Cotton soiled with lard) commercially available from CFT, NL-Vlaardingen
CFT C-S-78 (Cotton soiled with soybean oil) commercially available from CFT, NL-Vlaardingen
CFT PC-S-04 (Polyester/Cotton soiled with colored olive oil) commercially available from CFT, NL-Vlaardingen

### Determination of Molecular Weights

The number average (Mn) and weight average (Mw) molecular weights of the modified polymers prepared in following Examples were determined by measuring the unmodified polysines with gel permeation chromatography (GPC) and then converting the measured values to the molecular weights of the modified polymers based on corresponding degree of modification (DM). The unmodified polymers were analyzed in an aqueous eluent containing 0.1 M NaCl and 0.1 wt % trifluoroacetic acid through a cascade of columns (namely, TSKgel G4000, G3000, G3000, 300×7.8 mm) at 35° C. and flow rate of 0.8 ml/min. For the analysis, the unmodified polymers were dissolved in the eluent at the concentration of 1.5 mg/ml at room temperature and filtered through a 0.22 μm membrane, 2 h before injection of 100 μl in an Agilent 1100 chromatographic system. The relative molecular weight was characterized by refractive index detection against a calibration curve obtained with polyvinyl pyrrolidone standards, ranging between 620 and 1,060,000 g/mol.

### PREPARATION EXAMPLES

### Example 1: Preparation of Carboxymethylated Lysine-Based Polymer 1 at Lys:Asp=80:20

A 500 ml four-neck flask equipped with a stirrer, an internal thermometer, a gas inlet tube, a condenser with reduced-pressure connection and a Dean-Stark receiver, was charged with 220 g aqueous solution of L-lysine (50 wt %) and 12.6 g of aspartic acid suspended in 10 g water. The mixture was heated with stirring to an internal temperature of 160° C. for 3 h, with continuous water separation. Then, additional 12.5 g of aspartic acid was introduced into the reactor. After a total reaction time of 3.5 h, water was distilled off further under reduced pressure (900 mbar). Finally, 122 g of water distillate was collected and the highly viscous polymer was discharged to a silicone container as fast as possible while it was still hot and flowable. K-value was measured to be 9.7. The molar ratio of lysine structural units and aspartic acid structural units is 87:13, as determined by ¹H NMR.

A 250 ml four-neck flask equipped with a stirrer, an internal thermometer, a gas inlet tube, a condenser, was charged with 41.9 g sodium chloroacetate, 25 g lysine-based polymer and 75 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. After the reaction mixture was cooled down to 30° C., the pH of the solution was adjusted to 6 using aqueous HCl. Then, the modified polymer was precipitated with excess methanol (1:10 by weight) and filtered. Upon three successive precipitation steps, the product was dried over 16 h in a vacuum oven at 40° C. to obtain the final product having a solid content of 100%, and an active content of 98 wt % as determined by ¹H NMR. The degree of modification (DM) of the polymer as determined by ¹H NMR (2D) was 66%, and the molecular weights as determined were Mₙ=1304 g/mol and M_{w}=2168 g/mol.

### Example 2: Preparation of Carboxymethylated Lysine-Based Polymer 2 at Lys:Adi=80:20

A 500 ml four-neck flask equipped with a stirrer, an internal thermometer, a gas inlet tube, a condenser with reduced-pressure connection and a Dean-Stark receiver, was charged with 165 g aqueous solution of L-lysine (50 wt %) and 9.2 g of adipic acid suspended in 9.5 g water. The mixture was heated with stirring to an internal temperature of 160° C. for 2 h 50 min, with continuous water separation. Then, additional 11.5 g of adipic acid was introduced into the reactor. Finally, 98 g of water distillate was collected and the highly viscous polymer was discharged to a silicone container as fast as possible while it was still hot and flowable. K-value was measured to be 9.8. The molar ratio of lysine structural units and adipic acid structural units is 94:6, as determined by ¹H NMR.

A 250 ml four-neck flask equipped with a stirrer, an internal thermometer, a gas inlet tube, a condenser, was charged with 8.4 g sodium chloroacetate, 25 g lysine-based polymer and 75 g D.I. water. Then, the solution was heated up to 70° C. for 5 h. During the first 1.5 h, 33.5 g sodium chloroacetate and 28.8 g sodium hydroxide (50 wt %) were added into the flask in 3 portions, every 0.5 h. After the reaction mixture was cooled down to 30° C., the pH of the solution was adjusted to 4 using aqueous HCl. Then, the modified polymer was precipitated with excess methanol (1:10 by weight) and filtered. Upon three successive precipitation steps, the product was dried over 16 h in a vacuum oven at 40° C. to obtain the final product having a solid content of 100%, and an active content of 93 wt % as determined by ¹H NMR. The degree of modification (DM) of the polymer as determined by ¹H NMR was 104%, and the molecular weights as determined were Mₙ=1089 g/mol and M_{w}=1439 g/mol.

### Example 3: Preparation of Carboxymethylated Lysine-Based Polymer 3 at Lys:Ita=80:20

A 500 ml four-neck flask equipped with a stirrer, an internal thermometer, a gas inlet tube, a condenser with reduced-pressure connection and a Dean-Stark receiver, was charged with 134 g aqueous solution of L-lysine (50 wt %) and 6.7 g of itaconic acid suspended in 8 g water. The mixture was heated with stirring to an internal temperature of 160° C. for 2 h, with continuous water separation. Then, additional 8.3 g of itaconic acid was introduced into the reactor. Finally, 80 g of water distillate was collected and the highly viscous polymer was discharged to a silicone container as fast as possible while it was still hot and flowable. K-value was measured to be 10.6. The molar ratio of lysine structural units and itaconic acid structural units is 85:15, as determined by ¹H NMR.

A 250 ml four-neck flask equipped with a stirrer, an internal thermometer, a gas inlet tube, a condenser, was charged with 47.6 g sodium chloroacetate, 25 g lysine-based polymer and 75 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 91 wt % as determined by ¹H NMR. The degree of modification (DM) of the polymer as determined by ¹H NMR (2D) was 79%, and the molecular weights as determined were Mₙ=1142 g/mol and M_{w}=1649 g/mol.

### Example 4: Preparation of Carboxymethylated Lysine-Based Polymer 4 at Lys:Tar=80:20

A 500 ml four-neck flask equipped with a stirrer, an internal thermometer, a gas inlet tube, a condenser with reduced-pressure connection and a Dean-Stark receiver, was charged with 165 g aqueous solution of L-lysine (50 wt %) and 9.4 g of tartaric acid suspended in 9.5 g water. The mixture was heated with stirring to an internal temperature of 160° C. for 2 h 25 min, with continuous water separation. Then, additional 11.8 g of tartaric acid was introduced into the reactor. Finally, 93 g of water distillate was collected and the highly viscous polymer was discharged to a silicone container as fast as possible while it was still hot and flowable. K-value was measured to be 11.1. The molar ratio of lysine structural units and tartaric acid structural units is 78:22, as determined by ¹H NMR.

A 250 ml four-neck flask equipped with a stirrer, an internal thermometer, a gas inlet tube, a condenser, was charged with 41.6 g sodium chloroacetate, 25 g lysine-based polymer and 75 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 92 wt % as determined by ¹H NMR. The degree of modification (DM) of the polymer as determined by ¹H NMR was 79%, and the molecular weights as determined were Mₙ=892 g/mol and M_{w}=1176 g/mol.

### Example 5: Preparation of Carboxymethylated Lysine-Based Polymer 5 at Lys:Asp=90:10

A 500 ml four-neck flask equipped with a stirrer, an internal thermometer, a gas inlet tube, a condenser with reduced-pressure connection and a Dean-Stark receiver, was charged with 134 g of L-lysine (50 wt %), 13.6 g of aspartic acid and 50 g of water. The mixture was heated with stirring to an internal temperature of 160° C. for 4 h 25 min, with continuous water separation. Finally, 62 g of water distillate was collected and the highly viscous polymer was discharged to a silicone container as fast as possible while it was still hot and flowable. K-value was measured to be 11.9. The molar ratio of lysine structural units and aspartic acid structural units is 90:10, as determined by ¹H NMR.

A 250 ml four-neck flask equipped with a stirrer, an internal thermometer, a gas inlet tube, a condenser, was charged with 9.4 g sodium chloroacetate, 25 g lysine-based polymer and 75 g D.I. water. Then, the solution was heated up to 70° C. for 5 h. During the first 1.5 h, 37.7 g sodium chloroacetate and 32.4 g sodium hydroxide (50 wt %) were added into the flask in 3 portions, every 0.5 h. The reaction mixture was treated and the product was purified in the same manner as described in Example 1 to obtain the final product having a solid content of 100%, and an active content of 85 wt % as determined by ¹H NMR. The degree of modification (DM) of the polymer as determined by ¹H NMR was 53% (2D), and the molecular weights as determined were Mₙ=1357 g/mol and M_{w}=2868 g/mol.

### Example 6: Preparation of Carboxymethylated Lysine-Based Polymer 6 at Lys:Asp=80:20

A 500 ml four-neck flask equipped with a stirrer, an internal thermometer, a gas inlet tube, a condenser with reduced-pressure connection and a Dean-Stark receiver, was charged with 220 g aqueous solution of L-lysine (50 wt %) and 12.6 g of aspartic acid suspended in 10 g water. The mixture was heated with stirring to an internal temperature of 160° C. for 2 h 55 min, with continuous water separation. Then, additional 12.5 g of aspartic acid was introduced into the reactor. After a total reaction time of 3 h 20 min, water was distilled off further under reduced pressure (900 mbar). Finally, 129 g of water distillate was collected and the highly viscous polymer was discharged to a silicone container as fast as possible while it was still hot and flowable. K-value was measured to be 12.3. The molar ratio of lysine structural units and aspartic acid structural units is 80:20, as determined by ¹H NMR.

A 250 ml four-neck flask equipped with a stirrer, an internal thermometer, a gas inlet tube, a condenser, was charged with 83.7 g sodium chloroacetate, 50 g lysine-based polymer and 130 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 88 wt % as determined by ¹H NMR. The degree of modification (DM) of the polymer as determined by ¹H NMR (2D) was 51%, and the molecular weights as determined were Mₙ=1533 g/mol and M_{w}=5499 g/mol.

### Example 7: Preparation of Carboxymethylated Lysine-Based Polymer 7 at Lys:Tar=80:20

A 500 ml four-neck flask equipped with a stirrer, an internal thermometer, a gas inlet tube, a condenser with reduced-pressure connection and a Dean-Stark receiver, was charged with 165 g aqueous solution of L-lysine (50 wt %) and 9.5 g of tartaric acid suspended in 9.5 g water. The mixture was heated with stirring to an internal temperature of 160° C. for 2 h 25 min, with continuous water separation. Then, additional 11.8 g of tartaric acid was introduced into the reactor. After a total reaction time of 2 h 45 min, water was distilled off further under reduced pressure (900 mbar). Finally, 96 g of water distillate was collected and the highly viscous polymer was discharged to a silicone container as fast as possible while it was still hot and flowable. K-value was measured to be 12.7. The molar ratio of lysine structural units and tartaric acid structural units is 91:9, as determined by ¹H NMR.

A 250 ml four-neck flask equipped with a stirrer, an internal thermometer, a gas inlet tube, a condenser, was charged with 83.7 g sodium chloroacetate, 50 g lysine-based polymer and 130 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 79 wt % as determined by ¹H NMR. The degree of modification (DM) of the polymer as determined by ¹H NMR was 78%, and the molecular weights as determined were Mₙ=1355 g/mol and M_{w}=2545 g/mol.

### Example 8: Preparation of Carboxymethylated Lysine-Based Polymer 8 at Lys:Tar=90:10

A 500 ml four-neck flask equipped with a stirrer, an internal thermometer, a gas inlet tube, a condenser with reduced-pressure connection and a Dean-Stark receiver, was charged with 200 g aqueous solution of L-lysine (50 wt %) and 11.4 g of tartaric acid suspended in 20 g water. The mixture was heated with stirring to an internal temperature of 160° C., with continuous water separation. After a reaction time of 2 h 55 min, water was distilled off further under reduced pressure (900 mbar). Finally, 130 g of water distillate was collected and the highly viscous polymer was discharged to a silicone container as fast as possible while it was still hot and flowable. K-value was measured to be 12.0. The molar ratio of lysine structural units and tartaric acid structural units is 96:4, as determined by ¹H NMR.

A 250 ml four-neck flask equipped with a stirrer, an internal thermometer, a gas inlet tube, a condenser, was charged with 23.5 g sodium chloroacetate, 25 g lysine-based polymer and 49 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 93 wt % as determined by ¹H NMR. The degree of modification (DM) of the polymer as determined by ¹H NMR was 30%, and the molecular weights as determined were Mₙ=1278 g/mol and M_{w}=2650 g/mol.

### Example 9: Preparation of Carboxymethylated Lysine-Based Polymer 9 at Lys:Asp=90:10

A 500 ml four-neck flask equipped with a stirrer, an internal thermometer, a gas inlet tube, a condenser with reduced-pressure connection and a Dean-Stark receiver, was charged with 134 g of L-lysine, 13.6 g of aspartic acid and 50 g of water. The mixture was heated with stirring to an internal temperature of 160° C. for 4 h 25 min, with continuous water separation. Finally, 63 g of water distillate was collected and the highly viscous polymer was discharged to a silicone container as fast as possible while it was still hot and flowable. K-value was measured to be 12.1. The molar ratio of lysine structural units and aspartic acid structural units is 90:10, as determined by ¹H NMR.

A 500 ml four-neck flask equipped with a stirrer, an internal thermometer, a gas inlet tube, a condenser, was charged with 94.2 g sodium chloroacetate, 50 g lysine-based polymer and 150 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 82 wt % as determined by ¹H NMR. The degree of modification (DM) of the polymer as determined by ¹H NMR (2D) was 55%, and the molecular weights as determined were Mₙ=1380 g/mol and M_{w}=2917 g/mol.

### Example 10: Preparation of Carboxymethylated Lysine-Based Polymer 10 at Lys:Ita=80:20

A 500 ml four-neck flask equipped with a stirrer, an internal thermometer, a gas inlet tube, a condenser with reduced-pressure connection and a Dean-Stark receiver, was charged with 134 g aqueous solution of L-lysine (50 wt %) and 6.7 g of itaconic acid suspended in 8 g water. The mixture was heated with stirring to an internal temperature of 160° C. for 2 h, with continuous water separation. Then, additional 8.3 g of itaconic acid was introduced into the reactor. Finally, 78 g of water distillate was collected and the highly viscous polymer was discharged to a silicone container as fast as possible while it was still hot and flowable. K-value was measured to be 10.1. The molar ratio of lysine structural units and itaconic acid structural units is 80:20, as determined by ¹H NMR.

A 500 ml four-neck flask equipped with a stirrer, an internal thermometer, a gas inlet tube, a condenser, was charged with 83.7 g sodium chloroacetate, 50 g lysine-based polymer and 130 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 94 wt % as determined by ¹H NMR. The degree of modification (DM) of the polymer as determined by ¹H NMR (2D) was 86%, and the molecular weights as determined were Mₙ=1152 g/mol and M_{w}=1664 g/mol.

### Example 11: Preparation of Carboxymethylated Lysine-Based Polymer 11 at Lys:Glut=80:20

A 500 ml four-neck flask equipped with a stirrer, an internal thermometer, a gas inlet tube, a condenser with reduced-pressure connection and a Dean-Stark receiver, was charged with 100 g of L-lysine, 25.2 g of glutamic acid and 80 g of water. The mixture was heated with stirring to an internal temperature of 160° C. for 2 h 35 min, with continuous water separation. Finally, 81 g of water distillate was collected and the highly viscous polymer was discharged to a silicone container as fast as possible while it was still hot and flowable. K-value was measured to be 10.0. The molar ratio of lysine structural units and glutamic acid structural units is 79:21, as determined by ¹H NMR.

A 500 ml four-neck flask equipped with a stirrer, an internal thermometer, a gas inlet tube, a condenser, was charged with 83.7 g sodium chloroacetate, 40 g lysine-based polymer and 124 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 93 wt % as determined by ¹H NMR. The degree of modification (DM) of the polymer as determined by ¹H NMR was 79%, and the molecular weights as determined were Mₙ=1392 g/mol and M_{w}=2314 g/mol.

### Example 12: Preparation of Carboxymethylated Lysine-Based Polymer 12 at Lys:Glut=70:30

A 500 ml four-neck flask equipped with a stirrer, an internal thermometer, a gas inlet tube, a condenser with reduced-pressure connection and a Dean-Stark receiver, was charged with 100 g of L-lysine, 43.1 g of glutamic acid and 80 g of water. The mixture was heated with stirring to an internal temperature of 160° C., with continuous water separation. After a reaction time of 2 h 40 min, water was distilled off further under reduced pressure (900 mbar). Finally, 88 g of water distillate was collected and the highly viscous polymer was discharged to a silicone container as fast as possible while it was still hot and flowable. K-value was measured to be 12.3. The molar ratio of lysine structural units and glutamic acid structural units is 80:20, as determined by ¹H NMR.

A 500 ml four-neck flask equipped with a stirrer, an internal thermometer, a gas inlet tube, a condenser, was charged with 100.5 g sodium chloroacetate, 60 g lysine-based polymer and 160 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 96 wt % as determined by ¹H NMR. The degree of modification (DM) of the polymer as determined by ¹H NMR was 75%, and the molecular weights as determined were Mₙ=1768 g/mol and M_{w}=6339 g/mol.

### Example 13: Preparation of Carboxymethylated Lysine-Based Polymer 13 at Lys:Glut=70:30

A 500 ml four-neck flask equipped with a stirrer, an internal thermometer, a gas inlet tube, a condenser with reduced-pressure connection and a Dean-Stark receiver, was charged with 100 g of L-lysine, 43.1 g of glutamic acid and 80 g of water. The mixture was heated with stirring to an internal temperature of 160° C. for 2 h 35 min, with continuous water separation. Finally, 80 g of water distillate was collected and the highly viscous polymer was discharged to a silicone container as fast as possible while it was still hot and flowable. K-value was measured to be 10.1. The molar ratio of lysine structural units and glutamic acid structural units is 78:22, as determined by ¹H NMR.

A 500 ml four-neck flask equipped with a stirrer, an internal thermometer, a gas inlet tube, a condenser, was charged with 136.1 g sodium chloroacetate, 65 g lysine-based polymer and 202 g D.I. water. Then, the solution was heated up to 70° C. for 5 h. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product having a solid content of 100%, and an active content of 91 wt % as determined by ¹H NMR. The degree of modification (DM) of the polymer as determined by ¹H NMR was 118%, and the molecular weights as determined were Mₙ=917 g/mol and M_{w}=998 g/mol.

### Example 14: Preparation of Carboxymethylated Lysine-Based Polymer 14 at Lys:Adi=80:20

A 500 ml four-neck flask equipped with a stirrer, an internal thermometer, a gas inlet tube, a condenser with reduced-pressure connection and a Dean-Stark receiver, was charged with 165 g aqueous solution of L-lysine (50 wt %) and 9.2 g of adipic acid suspended in 9.5 g water. The mixture was heated with stirring to an internal temperature of 160° C. for 2 h 50 min, with continuous water separation. Then, additional 11.5 g of adipic acid was introduced into the reactor and water was distilled off further under reduced pressure (667 mbar). Finally, 105 g of water distillate was collected and the highly viscous polymer was discharged to a silicone container as fast as possible while it was still hot and flowable. K-value was measured to be 12.6. The molar ratio of lysine structural units and adipic acid structural units is 92:8, as determined by ¹H NMR.

A 250 ml four-neck flask equipped with a stirrer, an internal thermometer, a gas inlet tube, a condenser, was charged with 8.4 g sodium chloroacetate, 25 g lysine-based polymer and 75 g D.I. water. Then, the solution was heated up to 70° C. for 5 h. During the first 1.5 h, 33.5 g sodium chloroacetate and 28.8 g sodium hydroxide (50 wt %) were added into the flask in 3 portions, every 0.5 h. After the reaction mixture was cooled down to 30° C., the pH of the solution was adjusted to 4 using aqueous HCl. Then, the modified polymer was precipitated with excess methanol (1:10 by weight) and filtered. Upon three successive precipitation steps, the product was dried over 16 h in a vacuum oven at 40° C. to obtain the final product having a solid content of 100%, and an active content of 89 wt % as determined by ¹H NMR. The degree of modification (DM) of the polymer as determined by ¹H NMR was 76%, and the molecular weights as determined were Mₙ=1915 g/mol and M_{w}=4762 g/mol.

### Example 15: Preparation of Carboxymethylated Lysine-Based Polymer 15 at Lys:Tar=90:10

A 500 ml four-neck flask equipped with a stirrer, an internal thermometer, a gas inlet tube, a condenser with reduced-pressure connection and a Dean-Stark receiver, was charged with 165 g aqueous solution of L-lysine (50 wt %) and 9.4 g of tartaric acid suspended in 7.5 g water. The mixture was heated with stirring to an internal temperature of 160° C., with continuous water separation. After a reaction time of 2 h 25 min, water was distilled off further under reduced pressure (900 mbar). Finally, 100 g of water distillate was collected and the highly viscous polymer was discharged to a silicone container as fast as possible while it was still hot and flowable. K-value was measured to be 12.2. The molar ratio of lysine structural units and tartaric acid structural units is 91:9, as determined by ¹H NMR.

A 250 ml four-neck flask equipped with a stirrer, an internal thermometer, a gas inlet tube, a condenser, was charged with 10.5 g sodium chloroacetate, 25 g lysine-based polymer and 75 g D.I. water. Then, the solution was heated up to 70° C. for 5 h. During the first 1.5 h, 41.9 g sodium chloroacetate and 36.0 g sodium hydroxide (50 wt %) were added into the flask in 3 portions, every 0.5 h. The reaction mixture was treated and the product was purified in the same manner as described in Example 1 to obtain the final product having a solid content of 100%, and an active content of 98 wt % as determined by ¹H NMR. The degree of modification (DM) of the polymer as determined by ¹H NMR was 106%, and the molecular weights as determined were Mₙ=1895 g/mol and M_{w}=3941 g/mol.

### Example 16: Preparation of Carboxymethylated Lysine-Based Polymer 16 at Lys:Adi=90:10

A 500 ml four-neck flask equipped with a stirrer, an internal thermometer, a gas inlet tube, a condenser with reduced-pressure connection and a Dean-Stark receiver, was charged with 165 g aqueous solution of L-lysine (50 wt %) and 9.2 g of adipic acid suspended in 7.5 g water. The mixture was heated with stirring to an internal temperature of 160° C., with continuous water separation. After a reaction time of 2 h 45 min, water was distilled off further under reduced pressure (900 mbar). Finally, 102 g of water distillate was collected and the highly viscous polymer was discharged to a silicone container as fast as possible while it was still hot and flowable. K-value was measured to be 12.2. The molar ratio of lysine structural units and adipic acid structural units is 92:8, as determined by ¹H NMR.

A 250 ml four-neck flask equipped with a stirrer, an internal thermometer, a gas inlet tube, a condenser, was charged with 9.4 g sodium chloroacetate, 25 g lysine-based polymer and 75 g D.I. water. Then, the solution was heated up to 70° C. for 5 h. During the first 1.5 h, 37.7 g sodium chloroacetate and 32.4 g sodium hydroxide (50 wt %) were added into the flask in 3 portions, every 0.5 h. After the reaction mixture was cooled down to 30° C., the pH of the solution was adjusted to 4 using aqueous HCl. Then, the modified polymer was precipitated with excess methanol (1:10 by weight) and filtered. Upon three successive precipitation steps, the product was dried over 16 h in a vacuum oven at 40° C. to obtain the final product having a solid content of 100%, and an active content of 89 wt % as determined by ¹H NMR. The degree of modification (DM) of the polymer as determined by ¹H NMR was 76%, and the molecular weights as determined were Mₙ=1380 g/mol and M_{w}=2187 g/mol.

### Example 17: Preparation of Carboxymethylated Lysine-Based Polymer 17 at Lys:Tar=91:9

A 1000 ml four-neck flask equipped with a stirrer, an internal thermometer, a gas inlet tube, a condenser with reduced-pressure connection and a Dean-Stark receiver, was charged with 556 g aqueous solution of L-lysine (50 wt %) and 31.7 g of tartaric acid suspended in 31.8 g water. The mixture was heated with stirring to an internal temperature of 160° C. for 3 h 5 min, with continuous water separation. Then, additional 37.8 g of tartaric acid were introduced into the reactor and water was distilled off further under reduced pressure (900 mbar). Finally, 312 g of water distillate had been collected and the highly viscous polymer was discharged to a silicone container as fast as possible while it was still hot and flowable. K-value was measured to be 11.3.

A 500 ml four-neck flask equipped with a stirrer, an internal thermometer, a gas inlet tube, a condenser, was charged with 100.5 g sodium chloroacetate, 60 g polylysine copolymer and 160.5 g D.I. water. Then, the solution was heated up to 70° C. for 5 h. Meanwhile, pH was maintained at 10 by controlled addition of 48% wt. aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product, with a solid content of 100% and an active content of 84 wt %, as determined by ¹H NMR. The degree of modification (DM) of the polymer as determined by ¹H NMR was 94%, and the molecular weights as determined were Mₙ=1018 g/mol and M_{w}=1343 g/mol. Biodegradability according to OECD 301F (Manometric Respirometry) after 56 d was 33%.

### Example 18: Preparation of Carboxymethylated Lysine-Based Polymer 18 at Lys:Tar=82:18, 45 K-v 12.5, 13% DM

A 500 ml four-neck flask equipped with a stirrer, an internal thermometer, a gas inlet tube, a condenser with reduced-pressure connection and a Dean-Stark receiver, was charged with 165 g aqueous solution of L-lysine (50 wt %) and 9.4 g of tartaric acid suspended in 9.5 g water. The mixture was heated with stirring to an internal temperature of 160° C. for 2 h 21 min, with continuous water separation. Then, additional 11.8 g of tartaric acid were introduced into the reactor. After a total reaction time of 2 h 40 min, water was distilled off further under reduced pressure (900 mbar). Finally, 95 g of water distillate had been collected and the highly viscous polymer was discharged to a silicone container as fast as possible while it was still hot and flowable. K-value was measured to be 12.5.

A 250 ml four-neck flask equipped with a stirrer, an internal thermometer, a gas inlet tube, a condenser, was charged with 6.6 g sodium chloroacetate, 40 g polylysine copolymer and 50 g D.I. water. Then, the solution was heated up to 70° C. for 5 h. Meanwhile, pH was maintained at 10 by controlled addition of 48% wt. aqueous NaOH solution, using a control unit of Systag FlexyCube automated lab reactor, equipped with a peristaltic pump and a pH probe with high temperature electrolyte. The reaction mixture was treated and the product was purified in the same manner as described in Example 1 to obtain the final product, with a solid content of 100% and an active content of 95 wt %, as determined by ¹H NMR. The degree of modification (DM) of the polymer as determined by ¹H NMR was 13%, and the molecular weights as determined were Mₙ=900 g/mol and M_{w}=1690 g/mol.

### Comparative Example 1: Preparation of Carboxymethylated Polylysine Homopolymer 1

A 500 ml four-neck flask equipped with a stirrer, an internal thermometer, a gas inlet tube, a condenser with reduced-pressure connection and a Dean-Stark receiver, was charged with 100 g aqueous solution of L-lysine (50 wt %). The mixture was heated with stirring to an internal temperature of 160° C. for 45 minutes. Then, an aqueous solution of 400 g L-lysine (50 wt %) was dosed constantly over 3.5 h with continuous water separation. After a reaction time of 1 h, water was distilled off further under reduced pressure (670 mbar). Finally, 258 g of water distillate was collected and the highly viscous polymer was discharged to a silicone container as fast as possible while it was still hot and flowable. K-value was measured to be 10.5.

A 250 ml four-neck flask equipped with a stirrer, an internal thermometer, a gas inlet tube, a condenser, was charged with 10.5 g sodium chloroacetate, 19.1 g polylysine and 75 g D.I. water. Then, the solution was heated up to 70° C. for 5 h. During the first 1.5 h, 41.9 g sodium chloroacetate and 36 g sodium hydroxide (50 wt %) were added into the flask in 3 portions, every 0.5 h. After the reaction mixture was cooled down to 30° C., the modified polymer was precipitated with excess methanol (1:10 by weight) and filtered. Upon three successive precipitation steps, the product was dried over 16 h in a vacuum oven at 40° C. to obtain the final product having a solid content of 100%, and an active content of 94 wt % as determined by ¹H NMR. The degree of modification (DM) of the polymer as determined by ¹H NMR was 89%, and the molecular weights as determined were Mₙ=2112 g/mol and M_{w}=2560 g/mol.

### Comparative Example 2: Preparation of Carboxymethylated Polylysine Homopolymer 2

A 500 ml four-neck flask equipped with a stirrer, an internal thermometer, a gas inlet tube, a condenser with reduced-pressure connection and a Dean-Stark receiver, was charged with 100 g aqueous solution of L-lysine (50 wt %). The mixture was heated with stirring to an internal temperature of 160° C. for 45 minutes. Then, an aqueous solution of 400 g L-lysine (50 wt %) was dosed constantly over 3.5 h with continuous water separation. After a reaction time of 1 h, water was distilled off further under reduced pressure (670 mbar). Finally, 264 g of water distillate was collected and the highly viscous polymer was discharged to a silicone container as fast as possible while it was still hot and flowable. K-value was measured to be 12.2.

A 2000 ml four-neck flask equipped with a stirrer, an internal thermometer, a gas inlet tube, a condenser, was charged with 104.8 g sodium chloroacetate, 250 g polylysine and 750 g D.I. water. Then, the solution was heated up to 70° C. for 5 h. During the first 1.5 h, 419.2 g sodium chloroacetate and 360 g sodium hydroxide (50 wt %) were added into the flask in 3 portions, every 0.5 h. The reaction mixture was treated and the product was purified in the same manner as described in Comparative Example 1 to obtain the final product having a solid content of 100%, and an active content of 98 wt %. The degree of modification (DM) as determined by ¹H NMR was 70%, and the molecular weights as determined were Mₙ=2429 g/mol and M_{w}=3825 g/mol.

### Measurement of Chelating Performances

The carboxymethylated lysine-based polymer according to the present invention was studied for the chelating performance in terms of CaCO₃ dissolution (CCD) and Hydrogen peroxide stability.

### CaCO₃ Dissolution (CCD)

A 100 ml dispersion of CaCO₃ (0.005 mol/L) was titrated with a 2.5 wt % solution of a polymeric additive at room temperature without stirring. The transmissions were recorded initially and when 5 mL, 10 mL and 14 mL additive solution was added. The transmission measurement was done using Metrohm Photometer 662 including Phototrode and Metrohm Titrino 716 DMS at pH 11 (pH was adjusted to 11 and controlled by additional pH measurement with Metrohm 654). 100% transmission means that CaCO₃ in the system was completely dissolved. Test results are summarized in Table 1.

TABLE 1

Transmission (%)

| Additives | 0 mL | 5 mL | 10 mL | 14 mL |
|---|---|---|---|---|
| Modified PEI-1 | 71.1 | 73.4 | 78.6 | 82.4 |
| POLYMER 15 | 69.1 | 71.3 | 76.5 | 80.7 |

### Hydrogen Peroxide Stability

100 mL of aqueous solution containing Fe³⁺ ions or Mₙ²⁺ ions and an additive was prepared. Then, 6.67 g of 30 wt % H₂O₂ solution was added to obtain a solution comprising 2 wt % H₂O₂.

The pH was adjusted to a constant value with NaOH or HCl. After stirring for a certain time, the remaining H₂O₂ content was determined by iodometric titration. Test results are summarized in Table 2.

TABLE 2

| | | | 120 ppm Fe³⁺, pH 10, | 60 ppm Mn²⁺, |
|---|---|---|---|---|
| | | | H₂O₂ residual | pH 9, H₂O₂ residual |
| Additives | Dosage | | (%) after 0.5 h | (%) after 1 h |
| None | — | | 4 | 0 |
| EDTA Liquid | 0.6 | g ^{a)} | 78 | 84 |
| MGDA Liquid | 0.6 | g ^{a)} | 31 | 34 |
| POLYMER 15 | 0.6 | g ^{b)} | 43 | 57 |

^{a)} on a basis of active content,
^{b)} on a basis of solid content

It can be seen that the carboxymethylated lysine-based polymer according to the present invention shows desirable chelating ability as required by detergent compositions and acceptable stabilization ability as required by peroxy bleaching compositions.

### Measurement of Dispersing Performance

The carboxymethylated lysine-based polymers according to the present invention were studied for the dispersing performance in terms of CaCO₃ dispersing capacity (CCDC).

The calcium carbonate dispersing capacity (CCDC) allows the quantification of the ability of a polymeric dispersing agent to inhibit the precipitation of calcium carbonate in aqueous media. 1.0 g of a polymeric additive on a basis of solid content was dissolved in 100 ml water. Then, 10 ml of 10 wt % sodium carbonate solution was added. The pH value of the test solution was adjusted to pH 11 with 1 N NaOH. The test solution was titrated against a 0.25 M calcium acetate solution till it starts to become turbid. During titration the pH was kept constant by adjusting with 1 N NaOH or 1 N HCl. Test results are summarized in Table 3.

TABLE 3

| | CCDC |
|---|---|
| | (mg CaCO₃/g |
| Additives | additive) |
| Polymer PA-1 | 115 |
| Modified PEI-1 | 200 |
| POLYMER 2, lys:adi = 94:6, K-v 9.8, 104% DM | 108 |
| POLYMER 4, lys:tar = 78:22, K-v 11.1, 79% DM | 88 |
| POLYMER 5, lys:asp = 90:10, K-v 11.9, 53% DM | 101 |
| POLYMER 6, lys:asp = 80:20, K-v 12.3, 51% DM | 80 |
| POLYMER 7, lys:tar = 91:9, K-v 12.7, 78% DM | 87 |
| POLYMER 8, lys:tar = 96:4, K-v 12.0, 30% DM | 73 |
| POLYMER 9, lys:asp = 90:10, K-v 12.1, 55% DM | 89 |
| POLYMER 10, lys:ita = 80:20, K-v 10.1, 86% DM | 139 |
| POLYMER 11, lys:glut = 79:21, K-v 10.0, 79% DM | 196 |
| POLYMER 12, lys:glut = 80:20, K-v 12.3, 75% DM | 184 |
| POLYMER 13, lys:glut = 78:22, K-v 10.1, 118% DM | 214 |
| POLYMER 15, lys:tar = 92:8, K-v 12.2, 106% DM | 160 |
| HOMOPOLYMER 1, lysine, K-v 10.5, 89% DM | 195 |

The carboxymethylated lysine-based polymer according to the present invention shows acceptable or desirable dispersing performance as required by detergent compositions.

### APPLICATION EXAMPLES

The carboxymethylated lysine-based polymers according to the present invention were studied for the application in detergent formulations and the application in peroxy bleaching formulations.

### Anti-Greying Performance of a Liquid Laundry Formulation

A laundering process was simulated with Launder-o-meter (LP2 Typ, SDL Atlas Inc., USA). White test fabrics were washed in the same beaker together with 2.5 g EMPA101 and 2.5 g SBL 2004 and 20 steel balls at 40° C. in a wash liquor comprising a detergent with the formulation as shown in Table 5, and then rinsed and spin-dried for completing a wash cycle. The wash cycle was repeated two times with new clay dispersion and new wash liquor. After the rinsing in the third wash cycle, the test fabrics were dried in air instead. The details of the wash cycles are summarized in Table 4.

The anti-greying performance was characterized by Remission ΔR value of the soiled fabric before and after wash and determined by measuring the fabric with the spectrophotometer Elrepho 2000 from Datacolor at 460 nm. The higher the Remission ΔR value, the better is the performance. Results were summarized in Table 6.

TABLE 4

| Equipment | Launder-o-meter | |
|---|---|---|
| Detergent dosage | 4 | g/L |
| Detergent | Formulation as shown in Table 3 | |
| Water hardness | 2.5 mmol/L, Ca²⁺:Mg²⁺:HCO₃_{^{−}} 4:1:8 | |
| Ca:Mg:HCO3⁻ | 4:1:8 | |
| Washingtemperature | 40° | C. |
| Wash cycles | 3 (each 20 min) | |
| Wash liquor | 250 | ml |

| | |
|---|---|
| Fabric/liquor ratio | 1 kg/10 L |
| White test fabric | Cotton: wfk10A, wfk80A, wfk |
| (each 10 × 10 cm) | 12A, EMPA 221, T-shirt |
| | PES/Co blend: wfk20A |
| | Polyester: wfk30A |
| | Polyamid: EMPA 406 |
| Test soil | 2.5 g EMPA101 and 2.5 g SBL 2004 |

TABLE 5
Detergent Formulation

| Ingredient | Amount^{a)}, wt % |
|---|---|
| Anionic Surfactant DBS/LC | 5.5 |
| Edenor ® K12-18 | 2.4 |
| Anionic Surfactant AES | 5.4 |
| NaOH | 2.2 |
| Non-ionic Surfactant AEO-1 | 5.4 |
| 1,2-Propylene glycol | 6.0 |
| Ethanol | 2.0 |
| Sodium citrate | 3.0 |
| Additive as shown in Table 6 | 3.0 |
| Water | up to 100 |

^{a)}on a basis of active content for a non-polymeric ingredient and on a basis of solid content for a polymeric ingredient

TABLE 6

| | ΔR, Sum of |
|---|---|
| Additive | all fabrics |
| Blank | 517.7 |
| Polymer PA-2 | 508.0 |
| Modified PEI-1 | 524.1 |
| POLYMER 2, lys:adi == 94:6, K-v 9.8, 104% DM | 522.2 |
| POLYMER 6, lys:asp = 80:20, K-v 12.3, 51% DM | 530.9 |
| POLYMER 7, lys:tar = 91:9, K-v 12.7, 78% DM | 526.3 |
| POLYMER 10, lys:ita = 80:20, K-v 10.1, 86% DM | 519.1 |
| POLYMER 14, lys:adi = 92:8, K-v 12.6, 76% DM | 518.1 |
| POLYMER 15, lys:tar = 91:9, K-v 12.2, 106% DM | 525.1 |

It can be seen that the laundry formulations containing the carboxymethylated lysine-based polymer according to the present invention show appreciable anti-greying performance, which is even comparable to the formulations containing the commercially available non-biodegradable polymeric additive.

### Primary Detergency of a Liquid Laundry Formulation

The liquid laundry formulation as shown in Table 7 was measured for primary detergency in full-scale with a household washing machine (Miele W1935 WPS WTL) in accordance with the protocol as described in Table 8.

TABLE 7
Detergent Formulation

| Ingredient | Amount^{a)}, wt % |
|---|---|
| Anionic Surfactant DBS/LC | 5.5 |
| Edenor ® K12-18 | 2.4 |
| Anionic Surfactant AES | 5.4 |
| NaOH | 2.2 |
| Non-ionic Surfactant AEO-1 | 5.4 |
| 1,2-Propylene glycol | 6.0 |
| Ethanol | 2.0 |
| Sodium citrate | 3.0 |
| Additive as shown in Table 9 | 3.0 |
| Water | up to 100 |

^{a)}on a basis of active content for a non-polymeric ingredient and on a basis of solid content for a polymeric ingredient

TABLE 8

| Equipment | Miele W1935 WPSWTL | |
|---|---|---|
| Detergent dosage | 2 | g/L |
| Detergent | Formulation as shown in Table 5 | |
| Water hardness | 2.5 mmol/l, Ca²⁺:Mg²⁺:HCO₃_{^{−}}; 4:1:8 | |
| Washing temperature | 30° | C. |

| | |
|---|---|
| Wash cycles | 1 |
| Duration of cycle | Cotton wash short, 1:49 h |
| Washliquor | 15 L (main wash) |
| Fabric/liquor ratio | 1 kg/4 L |
| Test fabric: | Multisoil monitors: CFT C-S-10, |
| | CFT C-S-62, CFT C-S-78, CFT PC-S-04, |
| | EMPA 101, EMPA 125, wfk 10 PF, wfk 20 D |
| Ballast fabric | 3.5 kg white towels, |
| | 1 × ballast soil sheet wfk SBL 2004 |

The primary detergency is characterized by ΔE value calculated according to DIN EN ISO 11664-4 (June 2012) in accordance with following equation:

$$Δ E = {( Δ {L}^{* 2} + Δ {a}^{* 2} + Δ {b}^{* 2} )}^{1 / 2} ,$$

in which

$$Δ {L}^{⋆} = {L}_{w a shed}^{*} - {L}_{i nitial}^{⋆} ; Δ {a}^{*} = {a}_{w a s h e d}^{⋆} - {a}_{i nitial}^{⋆} ; and Δ {b}^{*} = {b}_{w a s h e d}^{⋆} - {b}_{initial}^{⋆} .$$

The L*, a*, b* values were measured on the stained fabrics before and after washing with the spectrophotometer MACH 5 from Colour Consult provided by OFT, NL-Vlaardingen. The higher the ΔE value, the better is the performance.

The test of each formulation including the washing in accordance with the protocol as described in Table 8 and characterization by ΔE was performed twice and the average value was given as the test result. Test results are summarized in Table 9.

TABLE 9

| | ΔE, Sum of the |
|---|---|
| Additive | stained fabrics |
| Blank | 161.9 |
| Modified PEI-2 | 162.7 |
| Polymer PA-2 | 165.6 |
| Modified PEI-1 | 166.7 |
| Copolymer CP-1 | 155.2 |
| POLYMER 2, lys:adi = 94:6, K-v 9.8, 104% DM | 169.0 |
| POLYMER 6, lys:asp = 80:20, K-v 12.3, 51% DM | 169.6 |
| POLYMER 7, lys:tar = 91:9, K-v 12.7, 78% DM | 169.3 |
| POLYMER 14, lys:adi = 92:8, K-v 12.6, 76% DM | 169.9 |
| POLYMER 15, lys:tar = 91:9, K-v 12.2, 106% DM | 172.8 |
| HOMOPOLYMER 2, lysine, K-v 12.2, 70% DM | 169.0 |

The test results demonstrate that the laundry formulations containing the carboxymethylated lysine-based polymer according to the present invention show primary detergency which is comparable or even better than the formulations containing the commercially available non-biodegradable polymeric additives or the carboxymethylated lysine homopolymer.

Synergy of the Carboxymethylated Lysine-Based Polymer with Enzyme in a Liquid Laundry Formulation

The liquid laundry formulation as shown in Table 10 was used as a base formulation for measuring the primary detergency regarding blood, milk and ink in accordance with the protocol as described in Table 11.

TABLE 10
Detergent Formulation

| Ingredient | Amount^{a)}, wt % |
|---|---|
| Anionic Surfactant LDBS 55 | 5 |
| Anionic Surfactant AES | 10 |
| Soap (coconut fatty acid) | 1 |
| Non-ionic Surfactant AEO-2 | 5 |
| Sodium citrate | 0.5 |
| Ethanol | 1.5 |
| Water | up to 100 |

^{a)}on a basis of active content for a non-polymeric ingredient and on a basis of solid content for a polymeric ingredient

TABLE 11

| Equipment | Terg-O-tometer, 16 Positions, 120 RPM | |
|---|---|---|
| Detergent dosage | 2 | g/l |
| Temperature | 30° | C. |
| Water hardness | 250 ppm (Ca:Mg 6:4) | |
| Duration of cycle | 20 | min |
| Volume of liquor | 1 | L |

| | |
|---|---|
| Liquor/Fabric ratio | NA |
| Number of cycles | 1 |
| Soiled fabric: | 6 pieces each 6 cm × 6 cm; |
| | CFT C-05: Cotton soiled with blood, milk, ink |
| Ballast fabric | None |

The primary detergency performance was characterized by Remission ΔR value of the soiled fabric before and after wash and determined by measuring the fabric with the spectrophotometer Elrepho 2000 from Datacolor at 457 nm. The higher the Remission ΔR value, the better is the performance. Results were summarized in Table 12.

TABLE 12

| | Enzyme^{a)}, | Polymeric Additive ^{b)}, | |
|---|---|---|---|
| | wt % | wt % | ΔR |
| Blank | 0 | 0 | 13.8 |
| Formulation A | 0 | 3 | 13.7 |
| Formulation B | 0 | 5 | 14.4 |
| Formulation C | 0.1 | 0 | 14.4 |
| Formulation D | 0.3 | 0 | 15.4 |
| Formulation E | 0.5 | 0 | 15.6 |
| Formulation F | 1.0 | 0 | 16.0 |
| Formulation G | 0.1 | 3 | 15.5 |
| Formulation H | 0.3 | 3 | 17.7 |
| Formulation I | 0.5 | 3 | 16.8 |
| Formulation J | 1.0 | 3 | 17.0 |
| Formulation K | 0.5 | 5 | 17.8 |

^{a)}Enzyme: Lavergy Pro 104 L, commercially available from BASF, the amount is on a basis of active content
^{b)} Polymeric Additive: POLYMER 16, the amount is on a basis of solid content

It can be seen from the test results of Formulation A and Formulation B, 3 wt % of the lysine-based polymer alone does not contribute to the primary detergency, and 5 wt % of the lysine-based polymer alone provides observable contribution to the primary detergency. It can also be seen from the test results of Formulations C to F, the enzyme could contribute to the primary detergency at various dosages.

Surprisingly, Formulation G containing 3 wt % of the lysine-based polymer and 0.1 wt % of the enzyme has significantly improved primary detergency than Formulation C containing 0.1 wt % of the enzyme. That is, the combination of the lysine-based polymer and the enzyme provides an improvement of primary detergency higher than that could be expected from the cooperative result of both. That is, a synergy of the lysine-based polymer and the enzyme was observed for Formulation G.

Likewise, the synergy of the lysine-based polymer and the enzyme can also be observed for Formulations H, I, J, K.

### Anti-filming Performance of an Automatic Dishwashing Formulation

A build-up test was performed in accordance with the general procedure as detailed in Table 13.

TABLE 13

| | |
|---|---|
| Dishwasher | Miele Active SC |
| Program | 65° C. in main cycle (with prewash), 65° C. rinse temperature, no rinse aid |
| | was used, no regenerating salt for ion exchange resin was used |
| Dishes | 3 knives (Solvex “Karina”, nickel-chromium knives) |
| | 3 Amsterdam 0.2 L drinking glasses |
| | 3 “OCEAN BLAU” breakfast plates (MELAMINE) |
| | 3 porcelain plates: 19 cm plates with rims flat |
| Ballast dishes | 8 tea cups, 8 porcelain plates |
| Arrangement | knives in the cutlery drawer, glasses in the upper baskets, plates in the |
| | lower basket |
| Dosage | 18 g of dishwashing detergent |
| Ballast soil | 50 g of ballast soil is added with the formulation after the prewash; for |
| | composition see below |
| Water hardness | 21° German hardness (Ca/Mg): HCO₃ (3:1): 1.35 |
| Cycles | 30; break in between for 1 h in each case (10 min with door open, 50 min |
| | with door closed) |
| Evaluation: | Visually after 30 cycles |

### Composition of the Ballast Soil

| | |
|---|---|
| Starch | 0.5% potato starch, 2.5% gravy |
| Fat | 10.2% margarine |
| Protein | 5.1% egg yolk, 5.1% milk |
| Others | 2.5% tomato ketchup, 2.5% mustard, |
| | 0.1% benzoic acid, 71.4% water |

Dishes after 30 cycles were evaluated visually in a darkened chamber under light behind an aperture diaphragm using a grading scale from 10 (very good) to 1 (very poor). Scores from 1-10 for filming (1=very severe filming, 10=no filming) were awarded.

The build-up test was performed with a phosphonate-free formulation as shown in Table 14. The test results of filming evaluation are summarized in Table 15.

TABLE 14
Formulation

| Ingredient | Amount^{a)}, wt % |
|---|---|
| Blaze ® Evity ® 150T | 2.5 |
| Stainzyme ® Plus Evity ® 12L | 1.0 |
| Dehypon ® E 127 & Dehypon ® | 5.0 |
| GRA (weight ratio 4/1) | |
| Additive as shown in Table 10 | 5.0 |
| Sodium percarbonate | 15.0 |
| Tetraacetylethylenediamine | 4.0 |
| Na₂Si₂O₅ (Britesil H 265 LC) | 2.0 |
| Na₂CO₃, Solvay Soda schwer | 23.7 |
| MGDA Granules | 40.0 |
| Sodium sulfate | 1.8 |

^{a)}on a basis of active content for a non-polymeric ingredient and on a basis of solid content for a polymeric ingredient

TABLE 15

| | Knives | Glass | Plastic | China | Sum |
|---|---|---|---|---|---|
| Blank | 1.0 | 1.0 | 1.0 | 1.0 | 4.0 |
| POLYMER 2 | 5.0 | 4.0 | 4.3 | 2.7 | 16.0 |
| POLYMER 4 | 4.0 | 3.0 | 3.0 | 2.3 | 12.3 |
| POLYMER 17 | 4.0 | 3.0 | 3.0 | 2.3 | 12.3 |

The test results demonstrate that the dishwashing formulations containing the carboxymethylated lysine-based polymer according to the present invention show appreciable anti-filming effect.

### Pulp Bleaching Application

An aqueous suspension containing 4.0 wt % of groundwood cellulose fibers, 1.5 wt % of hydrogen peroxide (10%) and 0.2 wt % of an additive relative to the amount of cellulose fibers, 0.75 wt % of sodium hydroxide and 2.0 wt % of sodium silicate was heated up to 70° C. After 1.5 h, the fibers were filtered, and then the filter cake was pressed and dried to a sheet of paper. The degree of Tappi whiteness of the dried sheet was determined by Datacolor DC 400 from Datacolor. The test results are summarized in Table 16.

TABLE 16

| | | EDTA | POLYMER | EDTA | POLYMER |
|---|---|---|---|---|---|
| Additive | Blank | Liquid | 15 | Liquid | 15 |
| Dosage | — | 0.2% ^{a)} | 0.2% ^{b)} | 0.4% ^{a)} | 0.4% ^{b)} |
| Tappi | 60.1 | 63.3 | 63.0 | 64.3 | 64.0 |
| Whiteness | | | | | |
| degree | | | | | |

^{a)} on a basis of active content,
^{b)} on a basis of solid content

The test results demonstrate that the carboxymethylated lysine-based polymer according to the present invention could stabilize hydrogen peroxide to an extent comparable to the conventional non-biodegradable chelating agent.

### Biodegradability of Carboxymethylated Lysine-Based Polymer

Polymer biodegradation after 4 and 8 weeks was tested respectively in accordance with the standard manometric respirometry method (OECD 301F).

TABLE 17

| | 28 | 56 |
|---|---|---|
| | days | days |
| | (%) | (%) |
| POLYMER 1, lys:asp = 87:13, K-v 9.7, 66% DM | 33 | 37 |
| POLYMER 2, lys:adi = 94:6, K-v 9.8, 104% DM | 43 | 58 |
| POLYMER 3, lys:ita = 85:15, K-v 10.6, 79% DM | 33 | 51 |
| POLYMER 4, lys:tar = 78:22, K-v 11.1, 79% DM | 43 | 58 |
| POLYMER 5, lys:asp = 90:10, K-v 11.9, 53% DM | 30 | 40 |
| POLYMER 6, lys:asp = 80:20, K-v 12.3, 51% DM | 40 | 48 |
| POLYMER 7, lys:tar = 91:9, K-v 12.7, 78% DM | 30 | 33 |
| POLYMER 8, lys:tar = 96:4, K-v 12.0, 30% DM | 30 | 39 |
| POLYMER 17, lys:tar = 91.9, K-v 11.3, 94% DM | 25 | 33 |
| HOMOPOLYMER 1, lysine, K-v 10.5, 89% DM | 15 | n.d. |
| HOMOPOLYMER 2, lysine, K-v 12.2, 70% DM | 12 | 13 |

The test results show that the carboxymethylated lysine-based polymer according to the present invention shows acceptable biodegradability and an appreciable improvement of the biodegradability compared with the carboxymethylated lysine homopolymers.

### Anti-Greying Performance of a Liquid Laundry Formulation

### Red Clay

A laundering process was simulated in lab using a Terg-o-meter (RHLG-IV, from Shanghai Bank Equipment Co. Ltd, China.) which includes 12 barrels with respective rotor blades as washing units, generally following GBT 13174-2008. The washing units were operated at the same stirring speed of 120 rotation per minute (rpm) and each contains 1L water. White test fabrics were washed in the same barrel together with 10 g red clay and oil mixtures at 30° C. in a wash liquor comprising a detergent with the formulation as shown in Table 18. After the washing, the fabrics were removed from the washing units, drained and rinsed twice in 10 L tap water for 30 seconds. The wash cycle was repeated two times with new red clay and oil mixtures and new wash liquor. After the rinsing in the third wash cycle, the test fabrics were dried in air instead. The details of the wash cycles are summarized in Table 19.

The anti-greying performance was characterized by Remission ΔR value of the soiled fabric before and after wash and determined by measuring the fabric with the spectrophotometer Elrepho 2000 from Datacolor at 457 nm. The higher the Remission ΔR value, the better is the performance. The results were summarized in Table 20.

TABLE 18

| Equipment | Terg-O-meter | |
|---|---|---|
| Detergent dosage | 2 | g/L |
| Detergent | Formulation as shown in Table 19 | |
| Water hardness | 2.5 mmol/L, Ca²⁺:Mg²⁺ = 3:2 | |
| Ca:Mg: HCO₃⁻ | 3:2 | |
| Washing temperature | 30° | C. |
| Wash cycles | 3 (each 30 min) | |
| Wash liquor | 250 | ml |

| | |
|---|---|
| Fabric/liquor ratio | N/A |
| White test fabric | Cotton: WFK 10A, WFK 80A, WFK 12A |
| (3 pieces for each, | PES/Co blend: WFK 20A |
| each 6 × 6 cm) | Polyester: WFK 30A |
| Test soil | 10 g red clay and oil mixtures |

TABLE 19
Detergent Formulation

| Ingredient | Amount^{a)}, wt % |
|---|---|
| Anionic Surfactant LAS | 5 |
| Anionic Surfactant AES | 10 |
| Non-ionic Surfactant AEO 7 | 5 |
| Ethanol | 1.5 |
| Sodium citrate | 0.5 |
| Additive as shown in Table xx | 1.0 |
| Water | up to 100 |

^{a)}on a basis of active content for all ingredients

TABLE 20

| | ΔR, Sum of |
|---|---|
| Additive | all fabrics |
| Blank | 275.4 |
| Modified PEI-2 | 267.9 |
| Modified PEI-1 | 173.6 |
| POLYMER 8, lys:tar = 96:4, K-v 12.0, 30% DM | 183.3 |
| POLYMER18, lys:tar = 82:18, K-v 12.5, 13% DM | 263.6 |

Better anti-greying performance can be observed with the inventive polymer in comparison to the blank sample and the commercial modified PEI.

### Yellow Clay

A laundering process was simulated in lab using a Terg-o-meter (RHLG-IV, from Shanghai Bank Equipment Co. Ltd, China.) which includes 12 barrels with respective rotor blades as washing units, generally following GET 13174-2008. The washing units were operated at the same stirring speed of 120 rotation per minute (rpm) and each contains 1L water. White test fabrics were washed in the same barrel together with 10 g yellow clay and oil mixtures at 30° C. in a wash liquor comprising a detergent with the formulation as shown in Table 21. After the washing, the fabrics were removed from the washing units, drained and rinsed twice in 10 L tap water for 30 seconds. The wash cycle was repeated two times with new yellow clay and oil mixtures and new wash liquor. After the rinsing in the third wash cycle, the test fabrics were dried in air instead. The details of the wash cycles are summarized in Table 22.

The anti-greying performance was characterized by Remission ΔR value of the soiled fabric before and after wash and determined by measuring the fabric with the spectrophotometer Elrepho 2000 from Datacolor at 457 nm. The higher the Remission ΔR value, the better is the performance. Results were summarized in Table 23.

TABLE 21

| Equipment | Terg-O-meter | |
|---|---|---|
| Detergent dosage | 2 | g/L |
| Detergent | Formulation as shown in Table xx | |
| Water hardness | 2.5 mmol/L, Ca²⁺:Mg²⁺ = 3:2 | |
| Ca:Mg: HCO3⁻ | 3:2 | |
| Washingtemperature | 30° | C. |
| Wash cycles | 3 (each 30 min) | |
| Wash liquor | 250 | ml |

| | |
|---|---|
| Fabric/liquor ratio | N/A |
| White test fabric | Cotton: WFK 10A, WFK 80A, WFK 12A |
| (3 pieces for each, | PES/Co blend: WFK 20A |
| each 6 × 6 cm) | Polyester: WFK 30A |
| Test soil | 10 g yellow clay and oil mixtures |

TABLE 22
Detergent Formulation

| Ingredient | Amount^{a)}, wt % |
|---|---|
| Anionic Surfactant LAS | 5 |
| Anionic Surfactant AES | 10 |
| Detergent Formulation | |
| Non-ionic Surfactant AEO 7 | 5 |
| Ethanol | 1.5 |
| Sodium citrate | 0.5 |
| Additive as shown in Table xx | 1.0 |
| Water | up to 100 |

^{a)}on a basis of active content for all ingredients

TABLE 23

| Additive | ΔR, Sum of all fabrics |
|---|---|
| Blank | 89.2 |
| Modified PEI-2 | 74.2 |
| Modified PEI-1 | 84.5 |
| POLYMER 8, lys:tar = 96:4, K-v 12.0, 30% DM | 72.8 |

An improved anti-greying performance can be observed with the inventive polymer in comparison to the blank sample and the commercial modified PEI.

### Primary Detergency of a Liquid Laundry Formulation

The liquid laundry formulation as shown in Table 24 was measured for primary detergency in full-scale with a household washing machine (Media MG80T1WS) in accordance with the protocol as described in Table 25. The results were summarized in Table 26.

TABLE 24
Detergent Formulation

| Ingredient | Amount^{a)}, wt % |
|---|---|
| Anionic Surfactant LDBS 55 | 5 |
| Anionic Surfactant AES | 10 |
| Soap (coconut fatty acid) | 1 |
| Non-ionic Surfactant AEO-2 | 5 |
| Sodium citrate | 0.5 |
| Ethanol | 1.5 |
| Additive as shown in Table xx | 1.0 |
| Water | up to 100 |

^{a)}on a basis of active content for all ingredients

TABLE 25

| Equipment | Media MG80T1WS | |
|---|---|---|
| Detergent dosage | 2 | g/L |
| Detergent | Formulation as shown in Table xx | |
| Water hardness | Tap water, ~1.5 mmol/l | |
| Washing temperature | 30° | C. |

| | |
|---|---|
| Wash cycles | 1 |
| Duration of cycle | Standard Mode, 1:04 h |
| Washliquor | 15 L (main wash) |
| Fabric/liquor ratio | 1 kg/4.3 L |
| Test fabric: | Multisoil monitors: SWI-E-114, |
| | CFT-C-BC-01, CFT-C-BC-02, CFT-PC-S-03 |
| Ballast fabric | 3.5 kg white fabrics (cotton:PES = 50%:50%), |
| | 1 × ballast soil sheet WFK SBL 2004 |

TABLE 26

| | ΔE, Sum of the |
|---|---|
| Additive | stained fabrics |
| Blank | 17.2 |
| Modified PEI-1 | 21.0 |
| Modified PEI-2 | 19.2 |
| POLYMER 8, lys:tar = 96:4, | 19.9 |
| K-v 12.0, 30% DM | |

Better primary detergency performance was observed with the inventive polymers in comparison with the blank sample and the commercial modified PEI.

1. A carboxymethylated lysine-based polymer comprising
(A) 60 to 99 mol % of structural units from lysine monomer,
(B) 1 to 40 mol % of structural units from at least one dicarboxylic acid of formula (I) or amide-forming derivative thereof 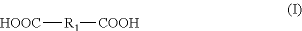
wherein
R₁ is a direct bond or an aliphatic linear hydrocarbylene, which is unsubstituted or substituted with at least one group selected from the group consisting of unsubstituted or substituted alkyl, unsubstituted or substituted alkoxy, unsubstituted or substituted alkylthio, unsubstituted or substituted alkylamino, di(alkyl)amino, alkylidene, hydroxyl, mercapto, amino and halogen.

2. The carboxymethylated lysine-based polymer according to claim 1, which comprises structural units (B) from at least one dicarboxylic acid of formula (I) or amide-forming derivative thereof wherein R₁ is a direct bond or an aliphatic linear C₁-C₂₄-hydrocarbylene which is unsubstituted or substituted with at least one group selected from the group consisting of unsubstituted or substituted C₁-C₁₈-alkyl, unsubstituted or substituted C₁-C₁₈-alkoxy, unsubstituted or substituted C₁-C₁₈-alkylthio, unsubstituted or substituted C₁-C₁₈-alkylamino, di(C₁-C₁₈-alkyl)amino, C₁-C₆-alkylidene, hydroxyl, mercapto, amino and halogen.

3. (canceled)

4. (canceled)

5. The carboxymethylated lysine-based polymer according to claim 1, which comprises structural units (B) from at least one dicarboxylic acid of formula (I) or amide-forming derivative thereof wherein R₁ is a direct bond, C₁-C₁₂-alkylene or C₂-C₁₂-alkenylene which are unsubstituted or substituted with at least one group selected from the group consisting of unsubstituted or substituted C₁-C₄-alkyl, unsubstituted or substituted C₁-C₄-alkoxy, unsubstituted or substituted C₁-C₄-alkylthio, unsubstituted or substituted C₁-C₄-alkylamino, di(C₁-C₄-alkyl)amino, C₁-C₄-alkylidene, hydroxyl, mercapto, amino and halogen.

6. The carboxymethylated lysine-based polymer according to claim 1, which comprises structural units (B) from at least one dicarboxylic acid of formula (I) or amide-forming derivative thereof wherein R₁ is a direct bond, C₁-C₁₂-alkylene or C₂-C₁₂-alkenylene which are unsubstituted or substituted with at least one group selected from the group consisting of unsubstituted or substituted C₁-C₄-alkyl C₁-C₄-alkylidene, hydroxyl, mercapto and amino.

7. (canceled)

8. The carboxymethylated lysine-based polymer according to claim 1, which comprises
(A) 70 to 97 mol % of the structural units from lysine monomer; and
(B) 3 to 30 mol % of the structural units from at least one dicarboxylic acid of formula (I) or amide-forming derivative thereof.

9. (canceled)

10. (canceled)

11. The carboxymethylated lysine-based polymer according to claim 1, which has a degree of modification by carboxymethylation of at least 20%.

12. The carboxymethylated lysine-based polymer according to claim 1, wherein the carboxymethylated lysine-based polymer is prepared from a lysine-based polymer having a K-value in the range of 8 to 20; or wherein the carboxymethylated lysine-based polymer have a number average molecular weight (Mn) in the range in the range of 400 to 10,000 g/mol and/or a weight average molecular weight (Mw) in the range of 500 to 3,500 g/mol.

13. A process for preparing a carboxymethylated lysine-based polymer, which comprises
thermal polycondensation of monomers comprising
(A) 60 to 95 mol % of lysine monomer,
(B) 5 to 40 mol % of at least one dicarboxylic acid of formula (I) or amide-forming derivative thereof 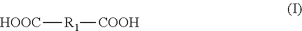
wherein
R₁ is a direct bond or an aliphatic linear hydrocarbylene, which is unsubstituted or substituted with at least one group selected from the group consisting of unsubstituted or substituted alkyl, unsubstituted or substituted alkoxy, unsubstituted or substituted alkylthio, unsubstituted or substituted alkylamino, di(alkyl)amino, alkylidene, hydroxyl, mercapto, amino and halogen,
to obtain a lysine-based polymer, and
carboxymethylation of the lysine-based polymer.

14. The process according to claim 13, wherein R₁ in formula (I) is a direct bond or an aliphatic linear C₁-C₂₄-hydrocarbylene which is unsubstituted or substituted with at least one group selected from the group consisting of unsubstituted or substituted C₁-C₁₈-alkyl, unsubstituted or substituted C₁-C₁₈-alkoxy, unsubstituted or substituted C₁-C₁₈-alkylthio, unsubstituted or substituted C₁-C₁₈-alkylamino, di(C₁-C₁₈-alkyl)amino, C₁-C₆-alkylidene, hydroxyl, mercapto, amino and halogen.

15. (canceled)

16. (canceled)

17. (canceled)

18. (canceled)

19. (canceled)

20. The process according to claim 13, wherein at least one dicarboxylic acid of formula (I) is selected from the group consisting of oxalic acid, malonic acid, succinic acid, maleic acid and fumaric acid, tartaric acid, aspartic acid, glutaric acid, itaconic acid, glutamic acid, adipic acid, pimelic acid, suberic acid, azelaic acid, sebacic acid, undecanedioic acid and dodecanedioic acid.

21. The process according to claim 13, which comprises thermal polycondensation of monomers comprising
(A) 70 to 90 mol % of lysine monomer, and
(B) 10 to 30 mol % of at least one dicarboxylic acid of formula (I) or amide-forming derivative thereof.

22. The process according to claim 13, wherein the lysine-based polymer has a K-value in the range of 8 to 20.

23. The process according to claim 13, wherein the carboxymethylated lysine-based polymer has a degree of modification by carboxymethylation of at least 20%.

24. The process according to claim 13, wherein the carboxymethylated lysine-based polymer have a number average molecular weight (Mn) in the range in the range of 400 to 10,000 g/mol.

25. A carboxymethylated lysine-based polymer obtained from the process according to claim 13.

26. A detergent composition comprising the carboxymethylated lysine-based polymer according to claim 1.

27. The detergent composition according to claim 26, wherein the detergent composition comprises 0.1 to 80% by weight of at least one surfactant selected from the group consisting of anionic surfactants, amphoteric surfactants and nonionic surfactants based on the total solid content of the detergent composition.

28. The detergent composition according to claim 26, wherein the detergent composition comprises the carboxymethylated lysine-based polymer in an amount of 0.5 to 30% by weight based on the total solid content of the detergent composition.

29. The detergent composition according to claim 26, wherein the detergent composition comprises at least one enzyme selected from the group consisting of lipases, hydrolases, amylases, proteases, cellulases, esterases, pectinases, lactases and peroxidases.

30. The detergent composition according to claim 26, wherein the detergent composition comprises the at least one enzyme in an amount of up to 5% by weight based on the total solid content of the detergent composition.

31. A peroxy bleaching composition, which comprises the carboxymethylated lysine-based polymer according to claim 1.

32. (canceled)

33. The peroxy bleaching composition according to claim 31, which is in a form of an aqueous hydrogen peroxide solution.

34. A process for bleaching cellulose fiber pulps with a peroxy bleaching agent, comprising using the carboxymethylated lysine-based polymer according to claim 1 as a stabilizer of the peroxy bleaching agent.

35. The process according to claim 34, wherein the carboxymethylated lysine-based polymer is incorporated into the cellulose fiber pulps in a dosage of 0.01 to 3% by weight based on the weight of the cellulose fiber pulps.

36. (canceled)

37. (canceled)
